(19) United States
(12) Patent Application Publication
(10) Pub. No.: US 2024/0289847 A1
(43) Pub. Date: Aug. 29, 2024

(54) INFORMATION PROCESSING APPARATUS, CONTROL METHOD FOR THE SAME, AND STORAGE MEDIUM

(71) Applicant: CANON KABUSHIKI KAISHA, Tokyo (JP)

(72) Inventors: KOUTA MURASAWA, Kanagawa (JP); KAZUYA OGASAWARA, Kanagawa (JP); TAKAYUKI YAMADA, Kanagawa (JP); KAZUFUMI KONDO, Kanagawa (JP); SHINJIRO HORI, Kanagawa (JP)

(21) Appl. No.: 18/582,352

(22) Filed: Feb. 20, 2024

(30) Foreign Application Priority Data
Feb. 24, 2023 (JP) 2023-026874

(51) Int. Cl. G06Q 30/0241; G06T 11/00; G06T 11/60

(52) U.S. Cl. CPC G06Q 30/0276; G06T 11/001; G06T 11/60; G06T 2200/24

(57) ABSTRACT

An information processing apparatus includes a first reception unit configured to receive, from a user, designation of a target impression to be given by a plurality of promotional materials to be generated, and a generation unit configured to generate the plurality of promotional materials based on the target impression and a design similarity degree between a plurality of promotional materials.

### BACKGROUND

### Field of the Disclosure

The present disclosure relates to an information processing apparatus, a control method for the information processing apparatus, and a storage medium.

### Description of the Related Art

There is proposed a conventional method of generating a poster by preparing a template storing information, such as shapes and the arrangement of images, characters, and graphics that are included in a poster, and automatically arranging the images, characters, and graphics in accordance with the template.

Japanese Patent No. 6537419 discusses generating a poster by selecting a template in ascending order of a difference between an impression evaluation value of a template and an impression evaluation value of an image.

In Japanese Patent Application Laid-Open No. 6537419, a template with a small difference between an impression evaluation value of a template and an impression evaluation value of an image is selected, but generating a poster representing an impression intended by a user is not considered at all.

Furthermore, generating a plurality of promotional materials that can be recognized as having a uniform design among the plurality of promotional materials in addition to generating one promotional material having a uniform design throughout the one promotional material, such as a poster, is not considered at all.

### SUMMARY

The present disclosure is directed to appropriately generating a design representing an impression of a brand that is uniform and is intended by the user, for a plurality of promotional materials.

To solve the above-described issue, according to an aspect of the present disclosure, an information processing apparatus includes a first reception unit configured to receive, from a user, designation of a target impression to be given by a plurality of promotional materials to be generated, and a generation unit configured to generate the plurality of promotional materials based on the target impression and a design similarity degree between a plurality of promotional materials.

Further features of the present disclosure will become apparent from the following description of exemplary embodiments with reference to the attached drawings.

### BRIEF DESCRIPTION OF THE DRAWINGS

FIG. 1 is a block diagram illustrating a hardware configuration of a multiple-promotional-material generation apparatus.

FIG. 2 is a software block diagram of a multiple-promotional-material generation application.

FIGS. 3A and 3B are diagrams illustrating a skeleton.

FIG. 4 is a diagram illustrating a coloration pattern.

FIG. 5 is a diagram illustrating a display screen to be provided by the multiple-promotional-material generation application.

FIG. 6 is a diagram illustrating a display screen to be provided by the multiple-promotional-material generation application.

FIG. 7 is a flowchart illustrating poster generation processing indicating quantification processing of a poster impression.

FIG. 8 is a diagram illustrating subjective assessment of a poster.

FIGS. 9A to 9C are flowcharts illustrating multiple-promotional-material generation processing.

FIGS. 10A to 10C are diagrams illustrating a selection method for a skeleton.

FIGS. 11A and 11B are diagrams illustrating selection methods for a coloration pattern and a font.

FIG. 12 is a software block diagram illustrating a layout unit in detail.

FIG. 13 is a flowchart illustrating layout processing.

FIGS. 14A to 14C are diagrams illustrating entry made using the layout unit.

FIGS. 15A to 15D are diagrams illustrating an operation of the layout unit.

FIG. 16 is a diagram illustrating a display screen to be provided by the multiple-promotional-material generation application.

FIG. 17 is a software block diagram of a multiple-promotional-material generation application.

FIG. 18 is a flowchart illustrating multiple-promotional-material generation processing.

FIGS. 19A to 19F are diagrams illustrating a combination generation unit.

FIGS. 20A and 20B are diagrams illustrating the combination generation unit.

FIGS. 21A to 21E are diagrams illustrating subjective assessment of a postcard.

FIG. 22 is a diagram illustrating subjective assessment of a postcard.

FIG. 23 is a diagram illustrating a display screen to be provided by a multiple-promotional-material generation application.

FIG. 24 is a flowchart illustrating reflection processing of promotional material data.

FIG. 25 is a diagram illustrating a display screen to be provided by the multiple-promotional-material generation application.

FIG. 26 is a diagram illustrating a display screen to be provided by the multiple-promotional-material generation application.

FIG. 27 is a flowchart illustrating the multiple-promotional-material generation processing.

FIG. 28 is a diagram illustrating a combination of promotional material sets.

### DESCRIPTION OF THE EMBODIMENTS

Hereinafter, exemplary embodiments of the present disclosure will be described in detail with reference to the accompanying drawings. The following exemplary embodiments are not intended to limit the present disclosure set forth in the appended claims. In addition, not all the combinations of features described in the present exemplary embodiment are used in the solution of the present disclosure. Like numbers refer to like components, and the description thereof will be omitted. In the present exemplary embodiment, a “promotional material” is a printed matter, such as a poster, a booklet, a menu of a shop, and a postcard, and refers to a design of an advertising medium for users, for example.

In the present exemplary embodiment, a “brand” represents the identity (corporate philosophy, vision, action guideline, characteristics) of a company or a store using a design. To make the brand widely-recognized by users, it is necessary to convey a message to users using a design with a consistent world-view. A uniform design with a consistent world-view is important to build brand recognition. For brand recognition, it is necessary to use a uniform design in creating a product package, a store design, and a publicity promotional material (website, booklet, poster, business card, and postcard), all of which provide contact with users. To create a uniform design, a plurality of promotional materials need to include similar design elements. Examples of design elements include logo (symbol), font, pattern, and color. If a plurality of promotional materials can include design elements, it can be felt that the plurality of promotional materials have a uniform design, allowing users to recognize a consistent world-view.

In the present exemplary embodiment, a design representing an impression of a brand that is uniform and is intended by a user can be automatically generated for a plurality of promotional materials. Even users that are inexperienced in design can generate a plurality of promotional materials for building brand recognition.

In a first exemplary embodiment, a description will be given using, as an example, a method of operating an application for multiple-promotional-material generation (hereinafter, will also be referred to as an “application”) in a multiple-promotional-material generation apparatus, and automatically generating a plurality of promotional materials. In the following description, “images” include still images and frame images clipped out from moving image unless otherwise noted.

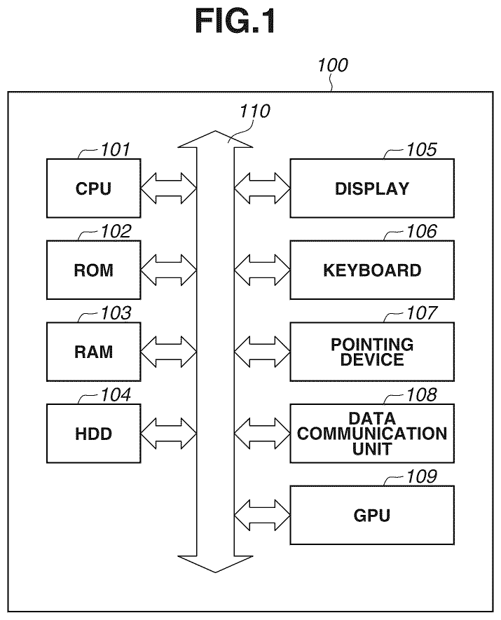

FIG. 1 is a block diagram illustrating a hardware configuration of a multiple-promotional-material generation apparatus 100. The multiple-promotional-material generation apparatus 100 is an information processing apparatus. For example, the multiple-promotional-material generation apparatus 100 is a personal computer (hereinafter, will be described as a PC) or a smartphone. In the present exemplary embodiment, the description will be given assuming that the multiple-promotional-material generation apparatus is a PC. The multiple-promotional-material generation apparatus 100 includes a central processing unit (CPU) 101, a read-only memory (ROM) 102, a random access memory (RAM) 103, a hard disk drive (HDD) 104, a display 105, a keyboard 106, a pointing device 107, and a data communication unit 108.

The CPU 101 comprehensively controls the multiple-promotional-material generation apparatus 100. By loading programs stored in the ROM 102, for example, onto the RAM 103 and executing the programs, the CPU 101 implements operations according to the present exemplary embodiment. In FIG. 1, the number of CPUs is one but a plurality of CPUs may be included.

The ROM 102 is a general-purpose ROM and stores programs to be executed by the CPU 101, for example. The RAM 103 is a general-purpose RAM and is used as a work memory for temporarily storing various types of information when programs are executed by the CPU 101, for example.

The HDD 104 is a storage medium (storage unit) for storing a database holding image files and processing results of image analysis, and a skeleton to be used by a multiple-promotional-material generation application.

The display 105 is a display unit that displays, to the user, a user interface (UI) according to the present exemplary embodiment, and a plurality of electronic promotional materials as a layout result of image data (hereinafter, will also be referred to as an “image”). The keyboard 106 and the pointing device 107 receive designation operations from the user. The display 105 may have a touch sensor function.

The keyboard 106 is used when the user enters a generation condition of a plurality of promotional materials desired to be generated on a UI displayed by the display 105, for example.

The pointing device 107 is used when the user clicks a button on a UI displayed by the display 105, for example.

The data communication unit 108 communicates with an external device via a network, such as a wired or wireless network. The data communication unit 108 transmits data laid out by an automatic layout function, for example, to a printer or a server that can communicate with the multiple-promotional-material generation apparatus 100.

A data bus 110 connects the blocks illustrated in FIG. 1, in such a manner that communication can be performed with each other.

The components illustrated in FIG. 1 are merely an example, and the components are not so limited. For example, the multiple-promotional-material generation apparatus 100 without the display 105 may display a UI on an external display.

The multiple-promotional-material generation application according to the present exemplary embodiment is stored in the HDD 104. The multiple-promotional-material generation application is activated by an operation, such as a click or a double click being executed by the user on an icon of the application that is displayed on the display 105, using the pointing device 107.

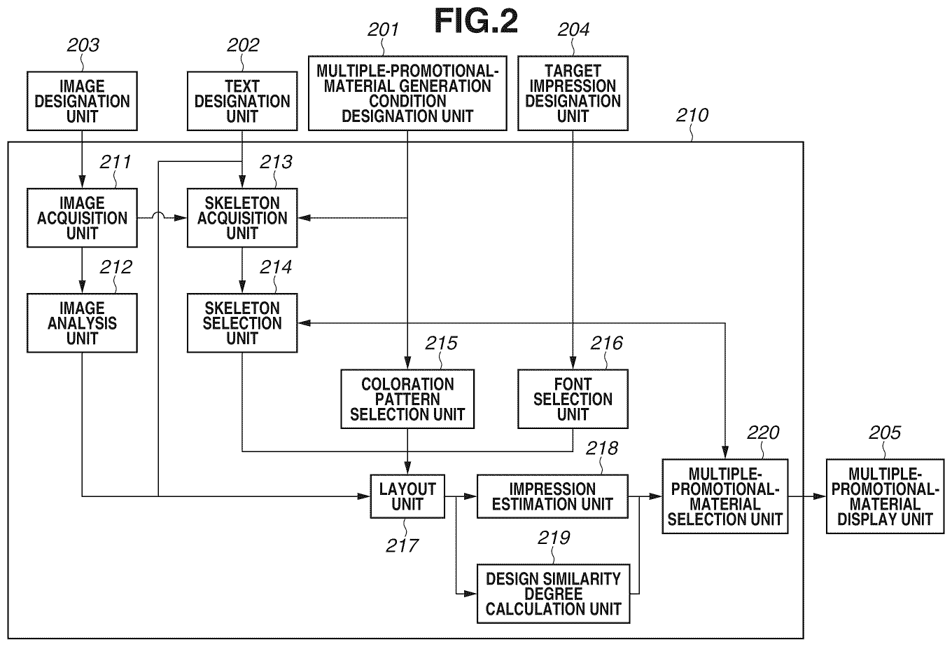

FIG. 2 is a software block diagram of the multiple-promotional-material generation application. The multiple-promotional-material generation application includes a multiple-promotional-material generation condition designation unit 201, a text designation unit 202, an image designation unit 203, a target impression designation unit 204, a multiple-promotional-material display unit 205, and a multiple-promotional-material generation unit 210. Furthermore, the multiple-promotional-material generation unit 210 includes an image acquisition unit 211, an image analysis unit 212, a skeleton acquisition unit 213, a skeleton selection unit 214, a coloration pattern selection unit 215, a font selection unit 216, a layout unit 217, an impression estimation unit 218, a design similarity degree calculation unit 219, and a multiple-promotional-material selection unit 220.

If the multiple-promotional-material generation application is installed onto the multiple-promotional-material generation apparatus 100, an activation icon is displayed on a top screen (desktop) of an operating system (OS) operating on the multiple-promotional-material generation apparatus 100. The activation icon displayed on the display 105 is operated (for example, double-clicked) by the user using the pointing device 107. If the activation icon is operated, a program of the multiple-promotional-material generation application that is stored in the HDD 104 is loaded onto the RAM 103 and executed by the CPU 101. The multiple-promotional-material generation application is accordingly activated.

Program modules respectively corresponding to the components illustrated in FIG. 2 are included in the above-described multiple-promotional-material generation application. Then, by executing each program module, the CPU 101 functions as the corresponding component illustrated in FIG. 2. Hereinafter, the description of the components illustrated in FIG. 2 will be given assuming that the components execute various types of processing. FIG. 2 is a software block diagram especially illustrating software blocks of the multiple-promotional-material generation unit 210 that executes a multiple-promotional-material automatic generation function.

The multiple-promotional-material generation condition designation unit 201 designates a multiple-promotional-material generation condition to be used by the multiple-promotional-material generation unit 210 in accordance with a UI operation performed using the pointing device 107. In the present exemplary embodiment, as a multiple-promotional-material generation condition, the multiple-promotional-material generation condition designation unit 201 designates types and use application categories of a plurality of promotional materials to be generated. Sizes of the plurality of promotional materials are associated with the types of the plurality of promotional materials. Furthermore, some promotional materials may have a plurality of types of sizes. In this case, the multiple-promotional-material generation condition designation unit 201 may designate actual dimension values of a width and a height, or may designate a sheet size, such as A1 or A2. The use application category refers to the category of the intended purpose for which the plurality of promotional materials are to be used. Examples of use application categories include restaurant, school event, and sale.

The text designation unit 202 designates character information to be arranged in a promotional material to be generated, in accordance with a UI operation performed using the keyboard 106. The character information to be arranged indicates a character string indicating a title, date and time, and a location, for example. The type of character information may vary depending on the type of a promotional material to be generated that has been selected by the multiple-promotional-material generation condition designation unit 201. For example, in a case where a poster is selected, the text designation unit 202 designates a title, a sub title, and a body text. In a case where a postcard is selected, a title, an address, and contact information are displayed. In a case where a plurality of promotional materials are selected, the text designation unit 202 may individually designate redundant information or collectively designate redundant information as one information item. In addition, the text designation unit 202 associates information indicating the type of character information, such as a title, date and time, or a location, with the character information in such a manner that the type is identifiable, and then outputs the character information to the skeleton acquisition unit 213 and the layout unit 217.

The image designation unit 203 designates one or a plurality of images stored in the HDD 104 that are to be arranged in a plurality of promotional materials. The image designation unit 203 may individually designate an image depending on the type of a promotional material to be generated that has been selected by the multiple-promotional-material generation condition designation unit 201, or may designate a common image. The image designation unit 203 may designate image data based on a structure of a file system including image data, such as a device and a directory, or may designate image data based on accompanying information or attribute information for identifying an image, such as image capturing date and time. The image designation unit 203 outputs a file path of the designated image to the image acquisition unit 211.

The target impression designation unit 204 designates one target impression for a plurality of promotional materials to be generated. The target impression refers to an impression requested to be finally held by the plurality of generated promotional materials. In the present exemplary embodiment, in accordance with a UI operation performed using the pointing device 107, the target impression designation unit 204 designates the intensity indicating the degree of an impression to be given, for a term representing the impression. Information indicating the target impression designated by the target impression designation unit 204 is shared by the skeleton selection unit 214, the coloration pattern selection unit 215, the font selection unit 216, and the multiple-promotional-material selection unit 220. The details of an impression will be described below.

Next, the configuration of the multiple-promotional-material generation unit 210 will be described in detail. A difference in promotional material can be made by selecting a skeleton of a targeted promotional material by the skeleton acquisition unit 213.

The image acquisition unit 211 acquires, from the HDD 104, one or a plurality of images that have been designated by the image designation unit 203. The image acquisition unit 211 outputs the acquired images to the image analysis unit 212. The image acquisition unit 211 also outputs the number of acquired images to the skeleton acquisition unit 213. Examples of images stored in the HDD 104 include still images and frame images clipped out from moving images. Still images and frame images are images acquired from an imaging device, such as a digital camera and a smart device. The imaging device may be included in the multiple-promotional-material generation apparatus 100, or may be included in an external device. In a case where the imaging device is an external device, images are acquired via the data communication unit 108. As another example, still images may be illustration images created by image-editing software or computer graphics (CG) images created using CG creation software. Still images and clipped images may be images acquired from a network or a server via the data communication unit 108. Examples of images acquired from a network or a server include a social networking service image (hereinafter, will also be referred to as an “SNS image”). In addition, a program executed by the CPU 101 analyzes data accompanying each image and determines a data source. For example, a destination that can acquire an SNS image may be managed in an application by causing the SNS image to be acquired from an SNS via the application. The images are not limited to the above-described images, and may be other types of images.

The image analysis unit 212 executes image data analysis processing on image data acquired from the image acquisition unit 211, using a method to be described below, and acquires information indicating an image feature amount to be described below. Specifically, the image analysis unit 212 executes object recognition processing to be described below, and acquires information indicating an image feature amount of the image data. In addition, the image analysis unit 212 associates the image data with the acquired information indicating the image feature amount, and outputs the image data to the layout unit 217.

The skeleton acquisition unit 213 acquires, from the HDD 104, one or a plurality of skeletons satisfying conditions designated by the multiple-promotional-material generation condition designation unit 201, the text designation unit 202, and the image acquisition unit 211. In the present exemplary embodiment, the skeleton refers to information indicating the arrangement of character strings, images, and graphics to be arranged in a plurality of promotional materials.

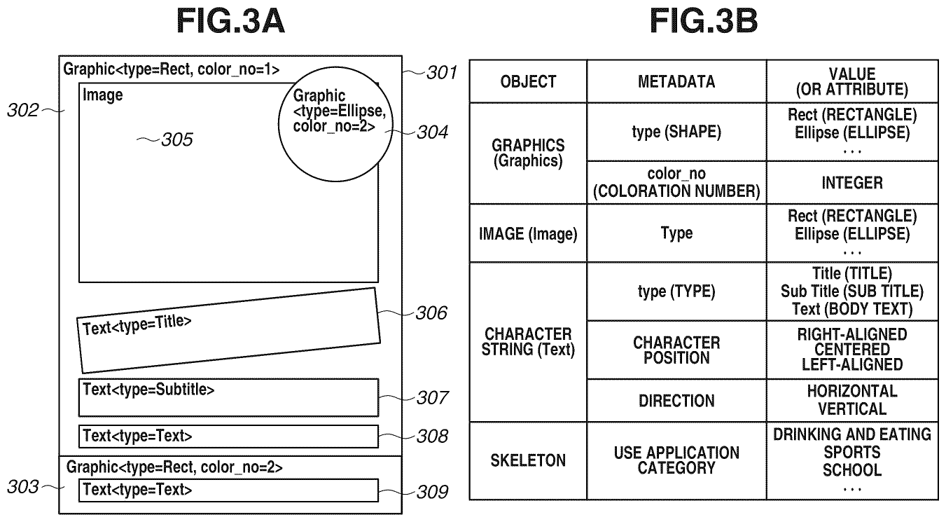

FIGS. 3A and 3B are diagrams illustrating an example of a skeleton for a poster among promotional materials. Three graphic objects 302, 303, and 304, one image object 305, and four character objects 306, 307, 308, and 309 as objects in which characters are to be arranged are arranged on a skeleton 301 illustrated in FIG. 3A. In addition to a position, a size, and an angle that indicate an arrangement location, metadata for generating a poster is also recorded for each object. FIG. 3B is a diagram illustrating an example of metadata. For example, types of character information to be arranged in the character objects 306 to 309 are held as attributes in metadata. FIGS. 3A and 3B illustrate that a title is arranged in the character object 306, a sub title is arranged in the character object 307, and body texts are arranged in the character objects 307 and 308. In addition, as for the graphic objects 302 to 304, shapes of the graphics and coloration numbers (coloration IDs) indicating coloration patterns are held as attributes in metadata. FIGS. 3A and 3B illustrate attributes of the graphic objects 302 and 303 as rectangles and an attribute of the graphic object 304 as an ellipse. In addition, a coloration number 1 is allocated to the graphic object 302 and a coloration number 2 is allocated to the graphic objects 303 and 304. The coloration number refers to information to be referred to in coloration to be described below. When different coloration numbers are allocated to objects, different colors are allocated to the objects. In addition, graphic objects may be painted and drawn in a uniform color. In addition, a graphic object may be drawn by clipping a pattern of a background illustration in the shape of the graphic object. The types and metadata of objects are not limited to these. For example, a map object for arranging a map, and a barcode object for arranging a quick response code (QR Code®) and a barcode may be included. In addition, as metadata of a character object, metadata indicating a width between lines or a width between characters may be included. A use application of a skeleton may be included in metadata, and the metadata may be used in the control for determining whether to use the skeleton, in accordance with the use application.

Skeletons may be individually managed for each of a plurality of promotional materials. Examples of skeletons include a skeleton for multiple promotional materials, a skeleton for menu, a skeleton for postcard, a skeleton for trifold leaflet, a skeleton for calendar, and a skeleton for banner. Furthermore, skeletons may be managed as groups among a plurality of promotional materials based on the relevance, such as arrangement. For example, a skeleton of a group 1 is assumed to be a skeleton about which the user feels a sense of luxury, and the same skeleton group ID is stored in metadata of skeletons of the skeleton group. With this configuration, based on a skeleton used in generating one promotional material, a skeleton to be applied to a different promotional material can be determined. Consequently, also in a case where designs of a plurality of promotional materials are generated, it is possible to generate a uniform design among the plurality of promotional materials.

Skeletons may be separately managed depending on a ratio between a width and a height. This allows acquisition of a skeleton with a ratio between a width and a height that is suitable for a size designated by the multiple-promotional-material generation condition designation unit 201.

Skeletons may be stored in the HDD 104 in a comma separated value (CSV) format or may be stored in a database (DB) format, such as Structured Query Language (SQL). The skeleton acquisition unit 213 outputs one or a plurality of skeletons acquired from the HDD 104, to the skeleton selection unit 214.

Among skeletons acquired from the skeleton acquisition unit 213, the skeleton selection unit 214 selects a skeleton that is suitable for the type of a promotional material designated by the multiple-promotional-material generation condition designation unit 201, and suitable for the target impression designated by the target impression designation unit 204. Then, the skeleton selection unit 214 outputs the selected skeleton to the layout unit 217. The selected skeleton satisfies the following condition. The skeleton selection unit 214 selects one or a plurality of skeletons for one type of promotional material, and selects one or a plurality of skeletons suitable for the target impression, for each promotional material type. Since the overall arrangement of each promotional material is determined based on a skeleton, preliminarily preparation of various types of skeletons can increase the range of variations of generated promotional materials.

The coloration pattern selection unit 215 acquires, from the HDD 104, one or a plurality of coloration patterns suitable for the target impression designated by the target impression designation unit 204, and outputs the acquired coloration pattern(s) to the layout unit 217. The coloration pattern refers to a combination of colors to be used in a promotional material. Furthermore, in a case where a color is designated by the multiple-promotional-material generation condition designation unit 201, the coloration pattern selection unit 215 also acquires, from the HDD 104, a coloration pattern including the color, and outputs the coloration pattern to the layout unit 217.

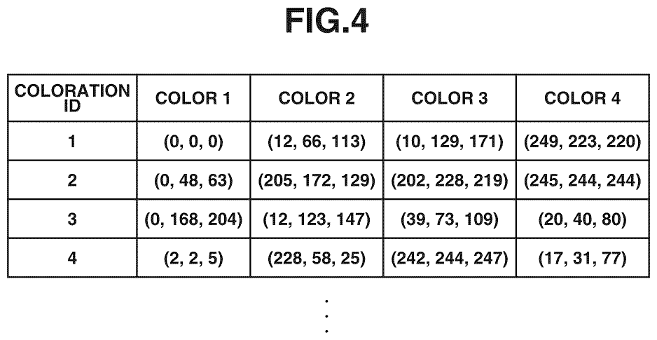

FIG. 4 is a diagram illustrating an example of a table of a coloration pattern. In the present exemplary embodiment, a coloration pattern is indicated as a combination of four colors. In FIG. 4, a coloration ID column indicates an ID for uniquely identifying a coloration pattern. Color 1 to color 4 columns indicate red, green, blue (RGB) color values from 0 to 255 of colors in the order of RGB ((R, G, B)=(0-255, 0-255, 0-255)). In the present exemplary embodiment, a coloration pattern including a combination of four colors is used, but the number of colors may be another number, or the number of colors may vary depending on the coloration pattern.

The font selection unit 216 selects one or a plurality of font patterns suitable for the target impression designated by the target impression designation unit 204, acquires the selected font pattern(s) from the HDD 104, and outputs the acquired font pattern(s) to the layout unit 217. The font pattern refers to a combination of at least one of a font for a title, a font for a sub title font, and a font for a body text. In a case where a font is designated by the multiple-promotional-material generation condition designation unit 201, the font selection unit 216 also acquires, from the HDD 104, a font pattern including the font, and outputs the acquired font pattern to the layout unit 217.

By laying out various types of data in each skeleton of one or a plurality of skeletons acquired from the skeleton selection unit 214, the layout unit 217 generates one or a plurality of promotional materials of the above-described type designated by the multiple-promotional-material generation condition designation unit 201. The layout unit 217 arranges a text acquired from the text designation unit 202 and image data acquired from the image analysis unit 212, in each skeleton. Then, the layout unit 217 applies a coloration pattern acquired from the coloration pattern selection unit 215, and applies a font pattern acquired from the font selection unit 216. Furthermore, in a case where a pattern is designated by the multiple-promotional-material generation condition designation unit 201, the layout unit 217 arranges a pattern in a graphic region in each skeleton. Furthermore, in a case where a logo is designated by the multiple-promotional-material generation condition designation unit 201, the layout unit 217 arranges a logo in each skeleton. The layout unit 217 outputs one or a plurality of pieces of generated promotional material data to the impression estimation unit 218.

Among the plurality of pieces of promotional material data acquired from the layout unit 217, the impression estimation unit 218 estimates an impression of each piece of promotional material data, and associates the estimated impression (estimated impression) with the promotional material data. Then, the impression estimation unit 218 outputs one or a plurality of pieces of promotional material data associated with the estimated impression, to the multiple-promotional-material selection unit 220.

The design similarity degree calculation unit 219 calculates a design similarity degree between different promotional materials among the plurality of pieces of promotional material data acquired from the layout unit 217, and associates the calculated design similarity degree with each piece of promotional material data. Then, the design similarity degree calculation unit 219 outputs one or a plurality of pieces of promotional material data associated with the design similarity degree, to the multiple-promotional-material selection unit 220.

The multiple-promotional-material selection unit 220 determines a combination of promotional materials based on a result of comparison between the target impression designated by the target impression designation unit 204 and an estimated impression of a plurality of pieces of promotional material data associated with the estimated impression that has been acquired from the impression estimation unit 218, and a calculation result of a design similarity degree between different promotional materials.

Which of an impression value and a design similarity degree is to be prioritized in the determination varies depending on a reflection degree of brand information designated by the multiple-promotional-material generation condition designation unit 201. The determined combination of promotional materials is stored into the HDD 104. The multiple-promotional-material selection unit 220 outputs the selected promotional material data to the multiple-promotional-material display unit 205.

The multiple-promotional-material display unit 205 outputs a plurality of promotional material images to be displayed on the display 105, in accordance with the promotional material combination acquired from the multiple-promotional-material selection unit 220. The plurality of promotional material images correspond to bitmap data, for example. The multiple-promotional-material display unit 205 displays the plurality of promotional material images on the display 105.

The multiple-promotional-material generation application may additionally provide a function (not illustrated) of editing the arrangement, colors, and shapes of images, texts, and graphics and further changing a design to a design desired by the user, by an additional operation performed by the user after a generation result is displayed on the multiple-promotional-material display unit 205.

By providing a function of printing, by a printer, a plurality of pieces of promotional material data stored in the HDD 104, under a condition designated by the multiple-promotional-material generation condition designation unit 201, it becomes possible for the user to obtain printed matters of a plurality of generated promotional materials.

### <Example of Display Screen>

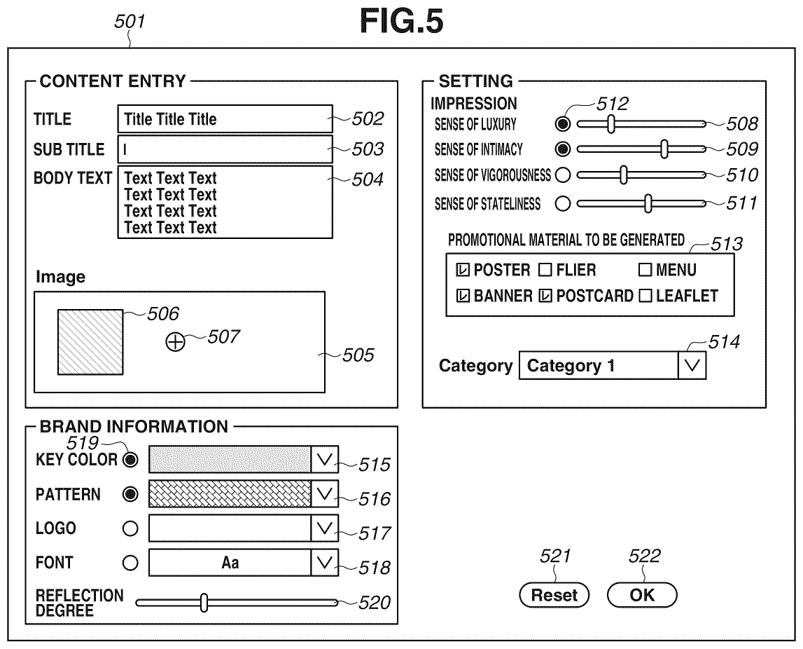

FIG. 5 is a diagram illustrating an example of an application activation screen 501 to be provided by the multiple-promotional-material generation application. The application activation screen 501 is displayed on the display 105. The user sets, via the application activation screen 501, a generation condition, a text, and an image of a plurality of promotional materials to be described below, and the multiple-promotional-material generation condition designation unit 201, the image designation unit 203, and the text designation unit 202 acquire settings made by the user, via this UI screen.

A title box 502, a sub title box 503, and a body text box 504 receive the designation of character information to be arranged in a plurality of promotional materials. In the present exemplary embodiment, three types of character information are received, but the types of character information are not limited to these. For example, character information, such as a location or date and time, may be additionally received. The designation of all types of character information needs not be always received, and a blank box may exist. The display may be changed in accordance with a promotional material designated in a generated promotional material designation region 513 to be described below. For example, in a case where a poster is selected, boxes for designating a title, a sub title, and a body text are displayed. In a case where a postcard is selected, boxes for designating a title, an address, and contact information are displayed.

In a case where a plurality of promotional materials are selected, redundant boxes may be separately displayed to individually receive designation, or may be collectively displayed as one box.

An image designation region 505 is a region for displaying an image to be arranged in a plurality of promotional materials. An image 506 indicates a thumbnail of a designated image. An image addition button 507 is a button for adding an image to be arranged. If the image addition button 507 is pressed by the user, the image designation unit 203 displays a dialog screen for selecting a file stored in the HDD 104, and receives image file selection made by the user. Then, a thumbnail of the selected image is added to the image designation region 505. An image may be individually designated depending on the type of a promotional material to be generated that has been selected in the generated promotional material designation region 513 to be described below, or a common image may be designated.

Each of impression sliders (impression slider bars or impression setting sliders) 508 to 511 is an object for setting a factor of one target impression for each promotional material to be generated. For example, the impression slider 508 is a slider for setting a factor of a target impression that is related to a sense of luxury. The target impression is set in such a manner that a sense of luxury of a promotional material becomes higher as the impression slider 508 is slid rightward, and the sense of luxury becomes lower (the promotional material looks more inexpensive) as the impression slider 508 is slid leftward. By combining factors of target impressions that have been set using the respective sliders, a target impression reflecting not only a factor of a target impression that has been set using one slider, but also factors of target impressions that have been set using other sliders is set. For example, in a case where a user operation is performed on a screen of the multiple-promotional-material generation application, and the impression slider 508 is set at a position closer to the right end than the center of the impression slider 508, and the impression slider 511 is set at a position closer to the left end than the center of the impression slider 511, a promotional material with a high sense of luxury and a low sense of stateliness (i.e., a promotional material with an elegant impression) is generated. For example, in a case where the impression slider 508 is set at a position closer to the right end than the center of the impression slider 508, and the impression slider 511 is set at a position closer to the right end than the center of the impression slider 511, by a user operation, a promotional material with a high sense of luxury and a high sense of stateliness (i.e., a promotional material with a gorgeous impression) is generated. In this manner, by combining factors of target impressions that are indicated by a plurality of impression sliders, even if the factor of a common target impression being “luxurious” is set, it becomes possible to set target impressions with different directionalities like the “elegant” target impression and the “gorgeous” target impression. That is, a target impression includes a plurality of factors indicating impressions, and the target impression is determined based on the plurality of factors, but the target impression may be determined based on one factor indicating an impression. In the present exemplary embodiment, a value is corrected to an integer value from −2 to +2 assuming that the value becomes −2 in a state in which a slider is set to the left end, and the value becomes +2 in a state in which a slider is set to the right end. These numerical values are values indicating that a corresponding impression is low when the value is −2, the corresponding impression is slightly low when the value is −1, the corresponding impression is applicable to neither low nor high when the value is 0, the corresponding impression is slightly high when the value is +1, and the corresponding impression is high when the value is +2. A value is corrected to an integer value from −2 to +2 for the purpose of facilitating distance calculation to be described below, by adapting a scale to a scale of an estimated impression. A numerical value range is not limited to this, and normalization may be executed using values from 0 to 1.

An impression enabling radio button 512 is a button for enabling the user to execute the control of enabling or disabling the setting of each target impression. By setting on/off by pressing the impression enabling radio button 512, the user can set enabling or disabling of the setting of each target impression. For example, if off is selected in the impression enabling radio button 512, a corresponding impression is excluded from impression control. For example, a user who desires to generate a calm promotional material with a low sense of vigorousness, and is not intended to specifically designate other impressions can generate a promotional material characterized in that a sense of vigorousness is low, by turning off the impression enabling radio buttons 512 of senses other than the sense of vigorousness. FIG. 5 illustrates a state in which on is selected for a sense of luxury and a sense of intimacy, and off is selected for a sense of vigorousness and a sense of stateliness. With this configuration, control with high flexibility becomes executable in such a manner that all target impressions are used in promotional material generation in some cases, and only a part of target impressions is used in promotional material generation in other cases. In a case where a state similar to a state in which each target impression is unset is caused when a corresponding impression slider is set at the left end (for example, in a case where a sense of luxury becomes 0 when the impression slider 508 is set at the left end), the impression enabling radio button 512 may be omitted. In this case, when the user desires to disable the setting of each target impression, by setting each impression slider at the left end, the user can disable the setting of a corresponding target impression.

The generated promotional material designation region 513 includes a plurality of checkboxes for determining the type of a promotional material to be generated. By a click operation performed by the user using the pointing device 107, it is possible to enable or disable the checkbox of a promotional material desired to be generated.

A category list box 514 enables the user to set a use application category of a plurality of promotional materials to be generated.

In the present exemplary embodiment, a component for enabling the user to enter brand information in addition to the above-described conditions is included. By entering brand information, designation can be made in such a manner that the same design element is used among different promotional materials. With this configuration, it is possible to enhance design uniformity among different promotional materials. Hereinafter, as an example of design elements, boxes for enabling the user to set a key color, a pattern, a logo, and a font will be described. These design elements merely indicate an example, and other items related to design may be set.

The user enters information regarding a color to be shared among different promotional materials, into a key color designation box 515. In the present exemplary embodiment, a color can be designated by displaying a list for designating a color and performing a click operation using the pointing device 107. Alternatively, a color may be designated by further displaying a UI (not illustrated) for designating a color and performing a click operation using the pointing device 107. For example, the UI is a UI for selecting a color by displaying a color palette in which a plurality of colors is arranged.

The user enters information regarding a pattern to be shared among different promotional materials, into a pattern designation box 516. In the present exemplary embodiment, a pattern can be designated by displaying a list for designating a pattern and performing a click operation using the pointing device 107. Alternatively, a pattern may be designated by selecting a file storing a pattern and performing a click operation using the pointing device 107. The file may be an image file (Joint Photographic Experts Group (JPEG) format file, bitmap file), or may be vector data (Portable Document Format (PDF) data).

The user enters information regarding a logo to be shared among different promotional materials, into a logo designation box 517. In the present exemplary embodiment, a logo can be designated by displaying a list for designating a logo and performing a click operation using the pointing device 107. Alternatively, a logo may be designated by selecting a file storing a logo and performing a click operation using the pointing device 107. The file may be an image file (JPEG format file, bitmap file), or may be vector data (PDF data).

The user enters information regarding a font to be shared among different promotional materials, into a font designation box 518. In the present exemplary embodiment, a font can be designated by displaying a list for designating a font and performing a click operation using the pointing device 107. Alternatively, a font may be designated by selecting a file storing a font and performing a click operation using the pointing device 107. A reflection degree slider bar 520 is used to set a weight indicating a degree to which the brand information set as described above is to be reflected as a design similarity degree. When the reflection degree slider bar 520 is set at the left end, the weight becomes 0 and the reflection degree is set to a reflection degree at which entered brand information is to be ignored. When the reflection degree slider bar 520 is set at the right end, the weight becomes 1, and entered brand information is to be inevitably used. For example, in a case where the reflection degree is designated as illustrated in FIG. 5, the reflection degree becomes 0.4, and in the above-described multiple-promotional-material selection unit 220, a weight that is based on a design similarity degree becomes 0.4, and a weight that is based on an impression value becomes 0.6. A brand information enabling radio button 519 is a button for enabling the user to execute the control of enabling or disabling the setting of each piece of brand information. By setting on/off by pressing the brand information enabling radio button 519, the user can set enabling or disabling of the setting of each piece of brand information. FIG. 5 illustrates a state in which a key color and a pattern are enabled.

A reset button 521 is a button for resetting each piece of setting information on the application activation screen 501.

If an OK button 522 is pressed by the user, the multiple-promotional-material generation condition designation unit 201, the text designation unit 202, the image designation unit 203, and the target impression designation unit 204 output the settings made on the application activation screen 501, to the multiple-promotional-material generation unit 210. At the time, the multiple-promotional-material generation condition designation unit 201 acquires the type of a promotional material to be generated, from the generated promotional material designation region 513, and acquires a use application category of a plurality of promotional materials to be generated, from the category list box 514. Furthermore, the multiple-promotional-material generation condition designation unit 201 acquires a color from the key color designation box 515, a pattern from the pattern designation box 516, a logo from the logo designation box 517, and a font from the font designation box 518. Furthermore, the multiple-promotional-material generation condition designation unit 201 acquires a reflection degree of brand information from the reflection degree slider bar 520, and acquires whether to enable the brand information, from the brand information enabling radio button 519.

The text designation unit 202 acquires character information to be arranged in a plurality of promotional materials, from the title box 502, the sub title box 503, and the body text box 504. The image designation unit 203 acquires a file path of an image to be arranged in a plurality of promotional materials, from the image designation region 505. The target impression designation unit 204 acquires a target impression of a plurality of promotional materials to be generated, from the impression sliders 508 to 511 and the impression enabling radio button 512. The multiple-promotional-material generation condition designation unit 201, the text designation unit 202, the image designation unit 203, and the target impression designation unit 204 may edit values set on the application activation screen 501. For example, the text designation unit 202 may remove an unnecessary blank character provided at the head or the tail end, from entered character information. In addition, the target impression designation unit 204 may correct values of target impressions designated using the impression sliders 508 to 511.

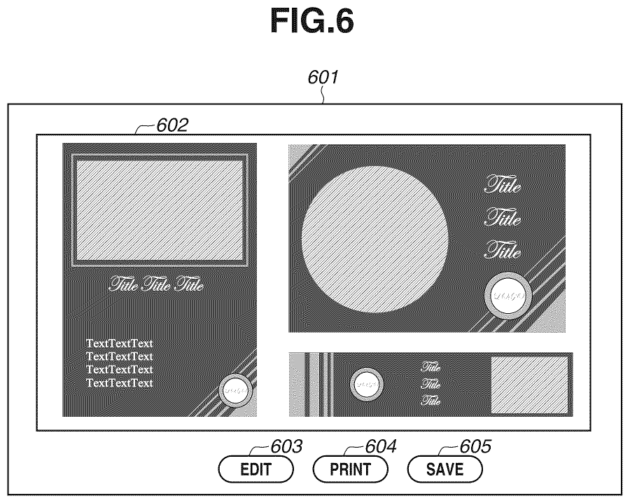

FIG. 6 is a diagram illustrating an example of a multiple-promotional-material preview screen 601 to be displayed on the display 105. On the multiple-promotional-material preview screen 601, a plurality of promotional material images generated by the multiple-promotional-material display unit 205 are displayed. If the OK button 522 on the application activation screen 501 is pressed and multiple-promotional-material generation is completed, a screen to be displayed on the display 105 transitions to the multiple-promotional-material preview screen 601.

A plurality of promotional material images 602 are promotional material images output by the multiple-promotional-material display unit 205. The multiple-promotional-material generation unit 210 generates promotional materials of types designated by the multiple-promotional-material generation condition designation unit 201, so that a plurality of types of generated promotional materials are displayed as a list as the plurality of promotional material images 602 on the multiple-promotional-material preview screen 601. By the user clicking a poster using the pointing device 107, the poster enters a selected state.

An edit button 603 enables the user to edit a plurality of promotional materials brought into the selected state, via a UI (not illustrated) providing an edit function.

A print button 604 enables the user to print a plurality of types of displayed promotional materials via a printer control UI (not illustrated).

A save button 605 enables the user to save a plurality of types of displayed promotional materials into the HDD 104 in a predetermined format in a re-editable state. The predetermined format may be a CSV format or may be a JavaScript Object Notation (JSON) format. Information to be saved includes estimated impressions and brand information (logo, pattern, key color, font) of promotional materials.

### <Impression Quantification of Multiple Materials>

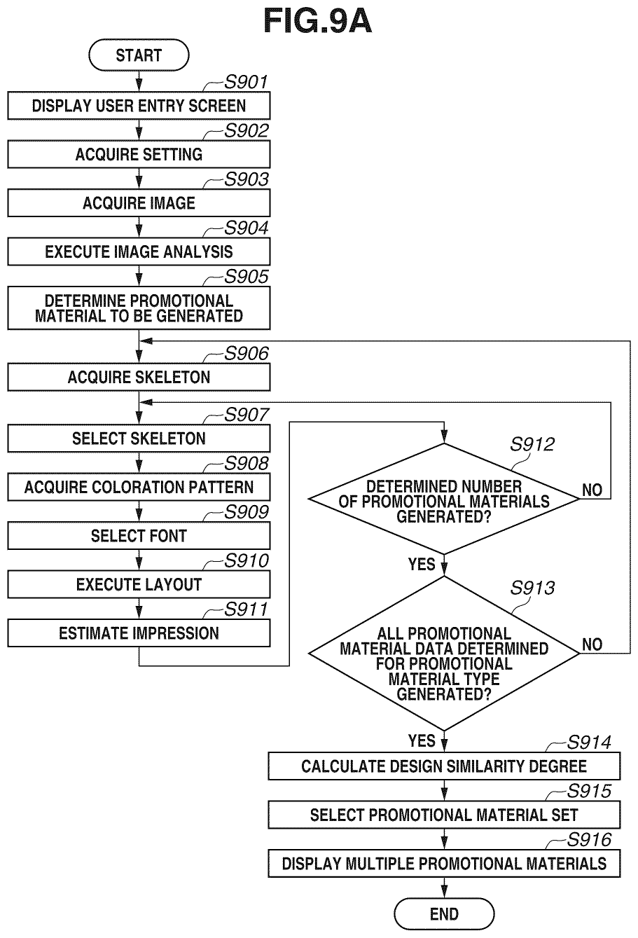

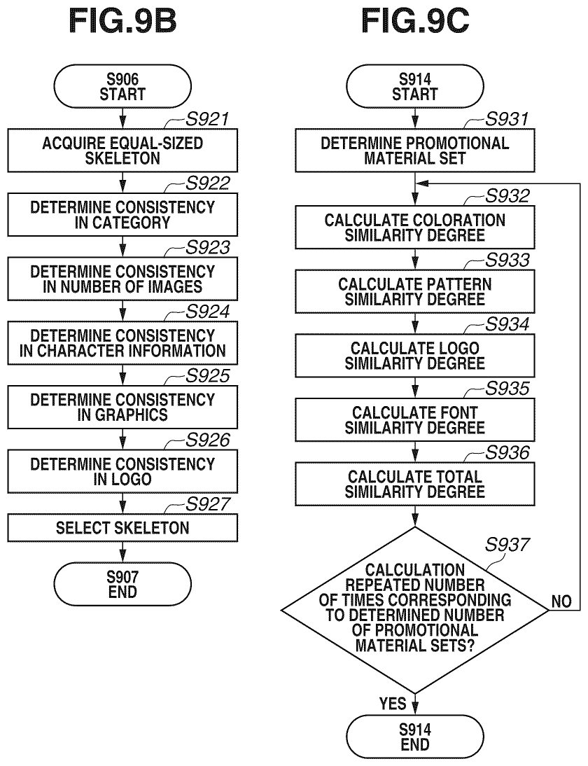

A description will now be given of a method of processing of quantifying impressions of a plurality of promotional materials, which is preprocessing for executing impression estimation processing to be described below in step S911 of FIG. 9A, and is used in multiple-promotional-material generation processing. In the present exemplary embodiment, the description will be given using, as an example, processing of quantifying an impression of a poster. By performing similar processing, it is possible to quantify impressions of other promotional materials. In promotional materials having close sizes and close use applications, an impression quantification result may be reused.

Processing of quantifying an impression of a poster is performed by a vendor that develops a poster generation application, in a development phase of the poster generation application. The processing of quantifying an impression of a poster may be executed by a poster generation apparatus, or may be executed by an information processing apparatus different from the poster generation apparatus. In a case where the processing is executed by an information processing apparatus different from the poster generation apparatus, the processing is executed by a CPU of the information processing apparatus.

In the processing of quantifying an impression of a poster, impressions of various posters that are given to people are quantified. At the same time, a correspondence relationship between a poster image and a poster impression is derived. This allows estimation of a poster impression from a generated poster image. If an impression can be estimated, by correcting a poster image, it becomes possible to control the impression of the poster, or search for a poster image having a certain target impression. The poster impression quantification processing is executed by operating an impression learning application for preliminarily learning an impression of a poster image before poster generation processing in a poster generation apparatus, for example.

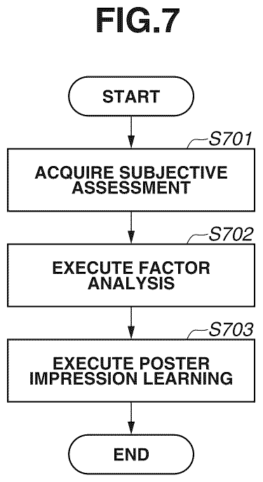

FIG. 7 is a flowchart illustrating poster impression quantification processing. The processing in the flowchart illustrated in FIG. 7 is implemented by the CPU 101 loading a program stored in the HDD 104, onto the RAM 103 and executing the program, for example. The poster impression quantification processing will be described with reference to FIG. 7. The processing illustrated in FIG. 7 is to be executed. A character “S” in the description of each process means a step in the flowchart (hereinafter, the same applies to the following description to be given in this specification).

In step S701, the CPU 101 acquires subjective assessment of an impression of a poster.

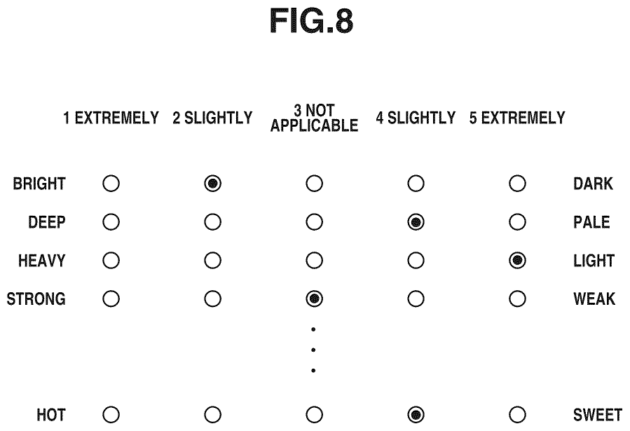

FIG. 8 is a diagram illustrating an example of a subjective assessment method for an impression of a poster. The CPU 101 presents a poster to a test subject, and acquires subjective assessment of an impression received from the poster, from the test subject. At the time, a measurement method, such as a Semantic Differential (SD) method or a Likert scale method, can be used. FIG. 8 illustrates an example of a questionnaire that uses the SD method. The questionnaire is a questionnaire for executing scoring based on pairs of adjectives recalled from a target poster, by presenting a plurality of adjective pairs representing impressions, to a plurality of graders. By acquiring subjective assessment results of a plurality of posters from a plurality of test subjects and then calculating an average value of responses to each adjective pair, the CPU 101 sets the average value as a representative numerical value of a corresponding adjective pair. The impression subjective assessment method may be a method other than the SD method, and is only required to be a method of defining a term representing an impression and a score corresponding to the term.

In step S702, the CPU 101 executes factor analysis of a subjective assessment result acquired by a subjective assessment acquisition unit. If the subjective assessment result is used as-is, the number of adjective pairs becomes the number of dimensions, and control becomes complicated. It is therefore desirable to reduce the number of dimensions to an efficient number of dimensions using an analysis method, such as principal component analysis or factor analysis. In the present exemplary embodiment, a description will be given assuming that the number of dimensions is reduced to four factors by factor analysis. As a matter of course, this value varies depending on a selected adjective pair in subjective assessment and a factor analysis method. In addition, an output of factor analysis is standardized. More specifically, each factor is scaled in such a manner that an average becomes 0 and a variance becomes 1 in a poster used in the analysis. Thus, −2, −1, 0, +1, and +2 of an impression designated by the target impression designation unit 204 can be respectively associated with −2a, −1a, average value, +1a, and +2a in each impression, and the calculation of the distance between a target impression and an estimated impression, which will be described below, becomes easier. In the present exemplary embodiment, a sense of luxury, a sense of intimacy, a sense of vigorousness, and a sense of stateliness illustrated in FIG. 5 are used as the four factors. These are names given for convenience to convey an impression to the user via a user interface, and each factor includes influences exerted by a plurality of adjective pairs on each other.

In step S703, the CPU 101 associates a poster image and an impression with each other. While quantification can be performed for a poster on which subjective assessment has been performed using the above-described method, it is necessary to estimate impressions of posters to be generated from now, without subjective assessment. The association between a poster image and an impression can be implemented by learning a model for estimating an impression from a poster image, using a deep learning method that uses a convolution neural network (CNN) or a machine learning method that uses a decision tree, for example. In the present exemplary embodiment, an impression learning unit performs supervised deep learning that uses the CNN, assuming that a poster image serves as an input and four factors serve as an output. More specifically, a deep learning model is generated by executing learning while regarding a poster image that has been subjected to subjective assessment and a corresponding impression, as ground truth, and an impression is estimated by inputting an unknown poster image to the learned model.

The deep learning model generated as described above is stored into the HDD 104, for example, and the impression estimation unit 218 loads the deep learning model stored in the HDD 104, onto the RAM 103 and implements the deep learning model.

The impression estimation unit 218 estimates an impression of a poster by converting poster data acquired from the layout unit 217, into an image, and operating the deep learning model loaded on the RAM 103, using the CPU 101 or a graphics processing unit (GPU) 109. In the present exemplary embodiment, a deep learning method is used, but a method to be used is not limited to this. For example, in a case where a machine learning method, such as a decision tree, is used, a machine learning model may be generated that extracts feature amounts, such as a luminance average value and an edge amount of a poster image, by image analysis, and estimates an impression based on the feature amounts.

FIGS. 9A to 9C are flowcharts illustrating multiple-promotional-material generation processing to be executed by the multiple-promotional-material generation unit 210 of the multiple-promotional-material generation application. As described above, the processing in the flowcharts illustrated in FIGS. 9A to 9C is started based on the facts that the setting of various setting items is made by the user on the multiple-promotional-material generation application and an OK button is pressed by the user.

The processing in the flowcharts illustrated in FIGS. 9A to 9C is implemented by the CPU 101 loading a program stored in the HDD 104, onto the RAM 103 and executing the program, for example. In the present exemplary embodiment, a description will be given assuming that the processing is executed by each component illustrated in FIG. 2 that functions by the CPU 101 executing the above-described poster generation application. The multiple-promotional-material generation processing will be described with reference to FIGS. 9A to 9C. A character “S” in the description of each process means a step in the flowcharts (hereinafter, the same applies to the following description to be given in this specification).

In step S901, the multiple-promotional-material generation application displays the application activation screen 501 on the display 105. The user enters each setting via a UI screen on the application activation screen 501 using the keyboard 106 and the pointing device 107.

In step S902, the multiple-promotional-material generation condition designation unit 201, the text designation unit 202, the image designation unit 203, and the target impression designation unit 204 acquire corresponding settings from the application activation screen 501. The multiple-promotional-material generation condition designation unit 201 acquires the type, the category, and brand information of a promotional material to be generated. As the type of a promotional material to be generated, the multiple-promotional-material generation condition designation unit 201 acquires the type of a promotional material to be generated, from the generated promotional material designation region 513. FIG. 5 illustrates a state in which there are three types corresponding to poster, banner, and postcard. As the category, the multiple-promotional-material generation condition designation unit 201 acquires a category from the category list box 514. FIG. 5 illustrates a state in which the category is set to drinking and eating. As the brand information, the multiple-promotional-material generation condition designation unit 201 acquires a key color, a pattern, a logo, a font, and a reflection degree. As the key color, the multiple-promotional-material generation condition designation unit 201 acquires a color designated in the key color designation box 515. Furthermore, the multiple-promotional-material generation condition designation unit 201 acquires information indicating whether the key color is to be used for promotional material generation, from the brand information enabling radio button 519. FIG. 5 illustrates a state in which the key color is set to a pale gray color and is to be used for promotional material generation. As the pattern, the multiple-promotional-material generation condition designation unit 201 acquires a pattern designated in the pattern designation box 516. Furthermore, the multiple-promotional-material generation condition designation unit 201 acquires information indicating whether the pattern is to be used for promotional material generation, from the brand information enabling radio button 519. FIG. 5 illustrates a state in which the pattern is a pattern of a slanted brick and is to be used for promotional material generation. As the logo, the multiple-promotional-material generation condition designation unit 201 acquires a logo designated in the logo designation box 517. Furthermore, the multiple-promotional-material generation condition designation unit 201 acquires information indicating whether the logo is to be used for promotional material generation, from the brand information enabling radio button 519. FIG. 5 illustrates a state in which a logo is not designated and is not to be used for promotional material generation. As the font, the multiple-promotional-material generation condition designation unit 201 acquires a font designated in the font designation box 518. Furthermore, the multiple-promotional-material generation condition designation unit 201 acquires information indicating whether the font is to be used for promotional material generation, from the brand information enabling radio button 519. FIG. 5 illustrates a state in which a Gothic font is designated but the font is not to be used for promotional material generation. The text designation unit 202 acquires character information to be arranged in a plurality of promotional materials, from the title box 502, the sub title box 503, and the body text box 504. FIG. 5 illustrates a state in which TittleTittleTittle is acquired as a title. FIG. 5 illustrates a state in which blank is acquired as a sub title. FIG. 5 illustrates a state in which TextTextText corresponding to four lines is acquired as a body text. The image designation unit 203 acquires an image designated in the image designation region 505. FIG. 5 illustrates a state in which an image with rising diagonal strokes from bottom left to top right is acquired. The target impression designation unit 204 acquires factors of target impressions from the impression sliders 508 to 511. Furthermore, the target impression designation unit 204 acquires information indicating whether an impression is to be used as a target impression, from the impression enabling radio button 512. FIG. 5 illustrates a state in which a sense of luxury is set to −1, a sense of intimacy is set to +1, a sense of vigorousness is set to −0.8, and a sense of stateliness is set to 0. Furthermore, FIG. 5 illustrates a state in which a sense of luxury and a sense of intimacy are used as target impressions, and a sense of vigorousness and a sense of stateliness are not used as target impressions.

In step S903, the image acquisition unit 211 acquires image data. Specifically, the image acquisition unit 211 identifies a corresponding image file of the image with the settings acquired in step S902. Then, the image acquisition unit 211 loads the identified image file from the HDD 104 onto the RAM 103.

In step S904, the image analysis unit 212 executes analysis processing on the image data acquired in step S903, and acquires information indicating a feature amount. Examples of the information indicating a feature amount include metainformation stored in an image, and information indicating an image feature amount that can be acquired by analyzing the image. These pieces of information are used in object recognition processing being analysis processing.

In the present exemplary embodiment, object recognition processing is executed as analysis processing, but the analysis processing is not limited to this, and another type of analysis processing may be executed. Furthermore, the processing in step S904 may be omitted. Hereinafter, the details of the processing performed by the image analysis unit 212 in step S904 will be described.

The image analysis unit 212 executes object recognition processing on the image acquired in step S903. The image analysis unit 212 can use a known method in the object recognition processing. In the present exemplary embodiment, an object is recognized by a classifier generated by deep learning. The classifier outputs a likelihood indicating whether a certain pixel included in an image is a pixel corresponding to an object, as a value in the range from 0 to 1, and recognizes that an object with a value exceeding a certain threshold value exists in the image. By recognizing an object image, the image analysis unit 212 becomes able to acquire the type and the position of an object, such as a face, a pet, such as a dog or a cat, a flower, food, a building, a stationary article, and a landmark.

In step S905, types of promotional materials to be generated, and the number of promotional materials to be generated for each promotional material type are determined. The number of types of promotional materials to be generated corresponds to the number of types of promotional materials that has been acquired in step S902. In FIG. 5, the number of types is three. Furthermore, the number of promotional materials that is predetermined for each promotional material type is regarded as the number of promotional materials to be generated. In the present exemplary embodiment, the predetermined number of promotional materials to be generated is five. More specifically, it is determined in FIG. 5 that 15 promotional materials in total including five posters, five postcards, and five banners are to be generated. In the present exemplary embodiment, a combination of promotional materials in which one promotional material is selected for one promotional material type is regarded as a promotional material set. FIG. 5 illustrates a state in which a combination of three promotional materials in total, one poster, one postcard, and one banner, is regarded as one promotional material set. In the present exemplary embodiment, the number of promotional materials to be generated is five but may be another number. The larger the number of promotional materials to be generated becomes, the easier it becomes to generate a promotional material set that has an impression closer to a target impression and has a high design similarity degree between promotional materials. With a smaller number of promotional materials to be generated, generation processing can be executed at higher speed. The processing in steps S906 to S912 to be described below is repeated the number of times corresponding to the number of types of promotional materials to be generated. Furthermore, the processing in steps S907 to S911 is repeated the number of times corresponding to the number of promotional materials to be generated. In other words, the processing in steps S907 to S911 is repeated the number of times corresponding to the number obtained by the number of types of promotional materials to be generated×the number of promotional materials to be generated.

In the present exemplary embodiment, the number of types of promotional materials to be generated is three and the number of promotional materials to be generated is five, so that the processing in steps S907 to S911 is repeated 15 times.

In step S906, the skeleton acquisition unit 213 acquires a skeleton satisfying various setting conditions of a processing target promotional material type. In the present exemplary embodiment, one skeleton is described in one file and the one file is stored in the HDD 104. The skeleton acquisition unit 213 sequentially loads skeleton files from the HDD 104 onto on the RAM 103, leaves skeletons satisfying the setting conditions, on the RAM 103, and deletes skeletons not satisfying the setting conditions, from the RAM 103. FIG. 9B is a flowchart illustrating condition determination processing to be performed by the skeleton acquisition unit 213. The condition determination processing to be performed by the skeleton acquisition unit 213 will be described in detail with reference to FIG. 9B. The processing in steps S921 to S927 is a sub-procedure of the processing in step S906.

In step S921, the skeleton acquisition unit 213 determines whether the size of a skeleton loaded onto the RAM 103 is equal to the size preset for the processing target promotional material type. In FIG. 5, the size of the poster is A2, the size of the postcard is 100 mm×148 mm, and the size of the banner is 360 mm×45 mm. The skeleton acquisition unit 213 determines whether sizes are equal, but may merely determine whether aspect ratios are equal. In this case, the skeleton acquisition unit 213 acquires a skeleton with the size equal to the processing target promotional material size by enlarging or reducing the coordinate system of a loaded skeleton.

In step S922, the skeleton acquisition unit 213 determines whether a use application category designated by the multiple-promotional-material generation condition designation unit 201 and the category of the skeleton are consistent with each other. A skeleton that is to be used only for a specific use application is prevented from being acquired, unless the use application category is selected, by describing the use application category in a skeleton file. In a case where a skeleton is specially designed for a specific use application such as a case where a pattern forming an impression of a school is drawn as graphics or a case where a pattern representing a sports goods is drawn, for example, this prevents the skeleton from being used for other use applications. In a case where a use application category has not been set on the application activation screen 501, the processing in step S922 is skipped.

In step S923, the skeleton acquisition unit 213 determines whether the number of image objects in the loaded skeleton and the number of images acquired by the image acquisition unit 211 are consistent with each other.

In step S924, the skeleton acquisition unit 213 determines whether a character object in the loaded skeleton and character information designated by the text designation unit 202 are consistent with each other. More specifically, the skeleton acquisition unit 213 determines whether the type of the character information designated by the text designation unit 202 exists in the skeleton. For example, it is assumed that character strings are designated in the title box 502 and the body text box 504 on the application activation screen 501, and a blank is designated in the sub title box 503. In this case, all character objects existing in the skeleton are searched. In a case where both a character object in which “title” is set and a character object in which “body text” is designated are found as the types of character information in metadata, the skeleton acquisition unit 213 determines that the character object is consistent with the character information. In other cases, the skeleton acquisition unit 213 determines that the character object is inconsistent with the character information.

In step S925, the skeleton acquisition unit 213 determines whether a graphic object exists in the loaded skeleton. In a case where a pattern is designated by the multiple-promotional-material generation condition designation unit 201, a graphic object for drawing a pattern needs to exist. In a case where a pattern is not designated by the multiple-promotional-material generation condition designation unit 201, the processing in step S925 is skipped.

In step S926, the skeleton acquisition unit 213 determines whether a logo object exists in the loaded skeleton. In a case where a logo is designated by the multiple-promotional-material generation condition designation unit 201, an object for drawing a logo needs to exist. In a case where a logo is not designated by the multiple-promotional-material generation condition designation unit 201, the processing in step S926 is skipped.

In step S927, a skeleton satisfying conditions through all pieces of determination processing in steps S921 to S926 remains in the RAM 103. The skeleton acquisition unit 213 selects a skeleton remaining on the RAM 103, as a skeleton to be used for poster generation.

As described above, the skeleton acquisition unit 213 stores, onto the RAM 103, a skeleton satisfying set conditions that are consistent with the conditions of a skeleton size, a use application category, the number of image objects, the type of a character object, the number of graphic objects, and the number of logo objects.

In the present exemplary embodiment, the skeleton acquisition unit 213 determines all skeleton files on the HDD 104, but the processing is not limited to this. For example, the poster generation application may pre-store, onto the HDD 104, a database associating a file path of a skeleton file and a search condition. In this case, by loading only a skeleton file on the database that satisfies a search condition, from the HDD 104 onto the RAM 103, the skeleton acquisition unit 213 can acquire a skeleton file at high speed. The search condition includes, for example, a skeleton size, the number of image objects, the type of a character object, the number of graphic objects, and the number of logo objects.

The processing in step S906 has been described above. The description will return to the flowchart of FIG. 9A.

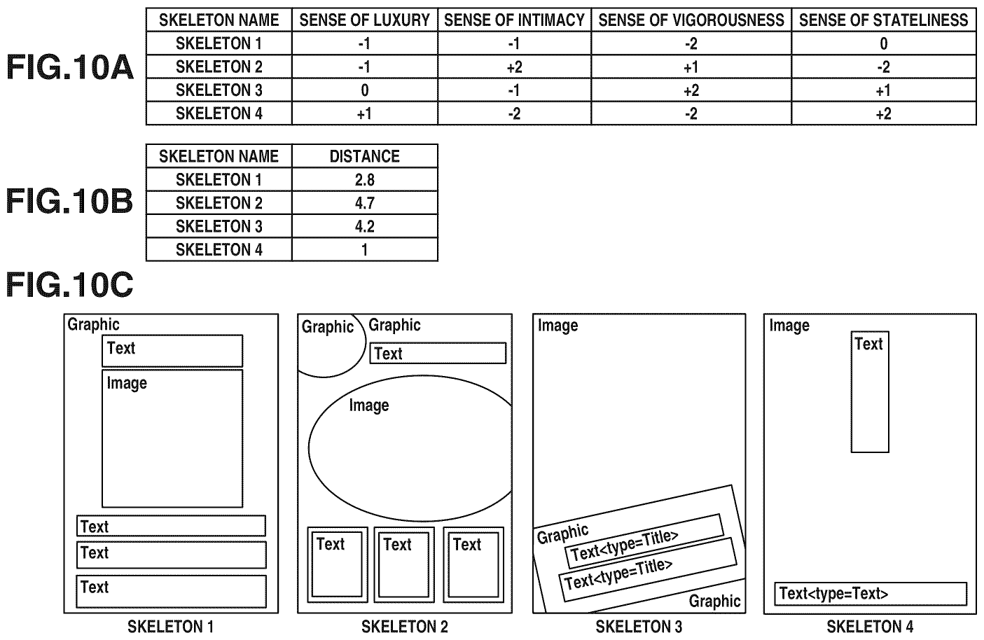

In step S907, the skeleton selection unit 214 selects, from among the skeletons acquired in step S906, a skeleton suitable for the target impression designated by the target impression designation unit 204. FIGS. 10A to 10C are diagrams illustrating an example of a method by which the skeleton selection unit 214 selects a skeleton as a skeleton of poster. Similar processing is to be executed on other types of promotional materials.

FIG. 10A is a diagram illustrating an example of a table associating a skeleton and an impression with each other. In FIG. 10A, file names of skeletons are described on the column of a skeleton name, and numbers (numerical values) indicating degrees to which the skeletons exert influences on impressions are described on the columns of a sense of luxury, a sense of intimacy, a sense of vigorousness, and a sense of stateliness. These numerical values are values indicating that a corresponding impression is low when the value is −2, the corresponding impression is slightly low when the value is −1, the corresponding impression is applicable to neither low nor high when the value is 0, the corresponding impression is slightly high when the value is +1, and the corresponding impression is high when the value is +2. First of all, the skeleton selection unit 214 calculates the distance between the target impression acquired from the target impression designation unit 204, and an impression of each skeleton that is indicated by a skeleton impression table illustrated in FIG. 10A. For example, in a case where the target impression is set to an impression with “a sense of luxury of +1, a sense of intimacy of −1, a sense of vigorousness of −2, and a sense of stateliness of +2”, distances calculated by the skeleton selection unit 214 are illustrated in FIG. 10B. In the present exemplary embodiment, a Euclidean distance is used as a distance (hereinafter, the Euclidean distance will be simply referred to as a distance). A smaller value of the Euclidean distance indicates a closer distance between a target impression and an impression of a skeleton. Next, the skeleton selection unit 214 selects top N skeletons with small distance values illustrated in FIG. 10B. In the present exemplary embodiment, the skeleton selection unit 214 selects top two skeletons. More specifically, the skeleton selection unit 214 selects a skeleton 1 and a skeleton 4. A setting method for N is only required to be a method of setting N to an integer equal to or larger than 1.

The value range of each impression in the skeleton impression table illustrated in FIG. 10A needs not be the same as the value range of the corresponding impression that is designated by the target impression designation unit 204. In the present exemplary embodiment, the value range of each impression that is designated by the target impression designation unit 204 ranges from −2 to +2, but the value range of each impression in the skeleton impression table may be different from the designated value range. In this case, the above-described distance calculation is executed after the value range in the skeleton impression table is scaled in accordance with the value range of a target impression. The distance to be calculated by the skeleton selection unit 214 is not limited to the Euclidean distance. Any method can be used of calculation of a distance between vectors, such as a Manhattan distance and a cosine similarity degree. If an impression is set to off via the press of the impression enabling radio button 512, a target impression of the impression is not set and the impression is excluded from the calculation to be made for distance calculation.

The skeleton impression table is preliminarily generated, for example, by generating poster images based on skeletons with a certain coloration pattern, a certain font, and a certain image and certain character data that are to be arranged in the skeletons and estimating the impressions of the poster images, and the skeleton impression table is stored in the HDD 104. In other words, by estimating impressions of poster images that use the same character color and the same image but are different in the arrangement of the same character and the same image, characteristics relative to a different skeleton are tabulated. At the time, it is desirable to execute processing of cancelling an impression given by a used coloration pattern or a used image, by standardizing all estimated impressions, or averaging impressions of a plurality of poster images generated from one skeleton using a plurality of coloration patterns or a plurality of images. This allows tabulation of influences on impressions that are exerted depending on the arrangement. For example, an impression of a skeleton with a small image is determined depending on elements, such as graphics or characters, irrespective of the image. As another example, if the arrangement of an image or a character is slanted, a sense of vigorousness is strong. FIG. 10C illustrates an example of skeletons corresponding to the skeletons 1 to 4 in FIG. 10A. For example, in the skeleton 1, an image object and character objects are regularly arranged and an area of an image is small, so that a sense of vigorousness becomes low. In the skeleton 2, a graphic object and an image object have circular shapes, so that a sense of intimacy becomes higher and a sense of stateliness becomes lower. In the skeleton 3, in addition to arranging an image object in a large size, by arranging a slanted graphic object superimposed on the image object, a sense of vigorousness becomes higher. In the skeleton 4, by arranging an image over the entire skeleton and minimizing a character object, a sense of stateliness becomes higher and a sense of vigorousness becomes lower. In this manner, in a case where a poster image includes a character or an image, a poster image with a different target impression is generated depending on the arrangement method of the character and/or the image. The generation method for the skeleton impression table is not limited to this. An impression may be estimated from a feature of arrangement information, such as an area or a coordinate of an image or a title character string, or manual adjustment may be performed. The skeleton impression table is stored in the HDD 104, and the skeleton selection unit 214 loads the skeleton impression table from the HDD 104 onto the RAM 103, and refers to the loaded skeleton impression table.

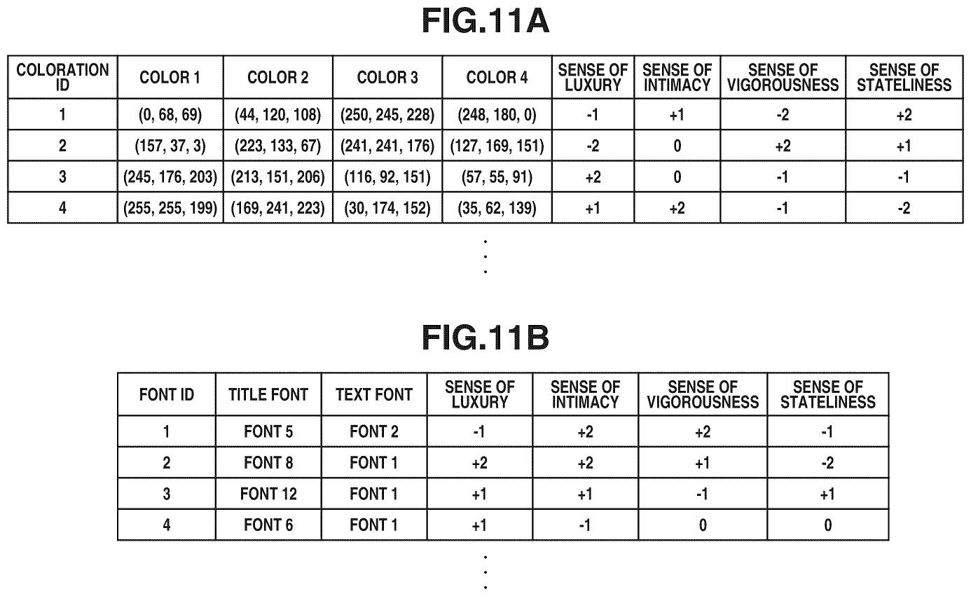

In step S908, the coloration pattern selection unit 215 selects a coloration pattern suitable for the target impression designated by the target impression designation unit 204. Furthermore, in a case where a color is designated by the multiple-promotional-material generation condition designation unit 201, the coloration pattern selection unit 215 selects a coloration pattern suitable for the designated color. A method of selecting a coloration pattern suitable for the target impression is similar to the method used in step S906. Referring to an impression table corresponding to coloration patterns, the coloration pattern selection unit 215 selects a coloration pattern in accordance with the target impression. FIG. 11A illustrates an example of a coloration pattern impression table associating a coloration pattern and an impression with each other. The coloration pattern selection unit 215 calculates values of distances between values of impressions indicated on the columns of impressions from a sense of luxury to a sense of stateliness in FIG. 11A and a target impression, and selects top N coloration patterns with small distance values. In the present exemplary embodiment, the coloration pattern selection unit 215 selects top two coloration patterns. Similarly to the skeleton impression table, the coloration pattern impression table can tabulate impression tendencies of coloration patterns by generating poster images having different coloration patterns using a certain skeleton, a certain font, and a certain image, other than the coloration patterns, and estimating the impressions. As a method of selecting a coloration pattern suitable for a designated color, a color close to a color included in a coloration pattern is selected. For example, in a case where a color with a distance ΔE of 2.0 or smaller is included in a CIE L*A*B* color space, the color is selected. Aside from this method, in a case where a color with a distance ΔRGB of 1.0 or smaller is included in an RGB color space, the color may be selected. Specifically, in a case where a designated color is represented as (R, G, B)=(0, 67, 69), the distance ΔRGB of a color 1 of a coloration ID 1 is equal to or smaller than 1.0 in FIG. 11A, and the color 1 is selected.

In step S909, the font selection unit 216 selects a combination of fonts that is suitable for the target impression designated by the target impression designation unit 204. Furthermore, in a case where a font is designated by the multiple-promotional-material generation condition designation unit 201, the font selection unit 216 selects a combination of fonts that is suitable for the designated font. A selection method for a combination of fonts that is suitable for the target impression is similar to the method used in step S906. More specifically, referring to an impression table corresponding to fonts, the font selection unit 216 selects a font in accordance with the target impression. FIG. 11B illustrates an example of a font impression table associating a font and an impression with each other. The font selection unit 216 calculates values of distances between values of impressions indicated on the columns of impressions from a sense of luxury to a sense of stateliness in FIG. 11B and a target impression, and selects top N fonts with small distance values. Similarly to the skeleton impression table, the font impression table can tabulate impression tendencies of fonts by generating poster images having different fonts, with a certain skeleton a certain coloration pattern, and a certain image, other than fonts, and estimating the impressions. As a method of selecting a combination of fonts that is suitable for a designated font, a combination of fonts including the designated font is selected. Furthermore, a combination of fonts having an impression value close to an impression value of font in a combination of fonts including the designated font may be further selected. It is thus possible to also select a font having an impression close to an impression of the designated font.

In step S910, the layout unit 217 generates a poster by setting character information, an image, coloration, a font, a pattern, and a logo in the skeleton selected by the skeleton selection unit 214.

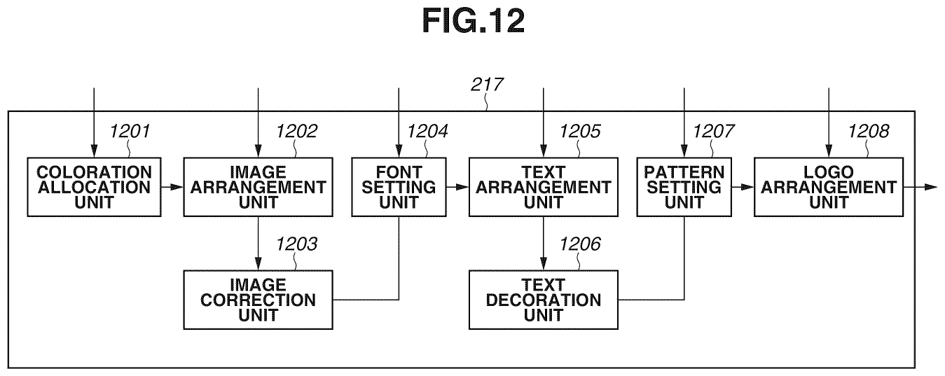

The processing to be executed by the layout unit 217 in step S910 will be described in detail with reference to FIGS. 12, 13, 14A to 14C, and 15A to 15D.

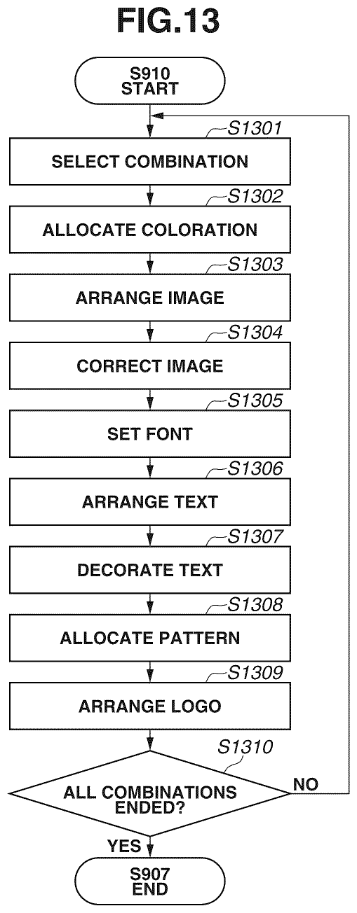

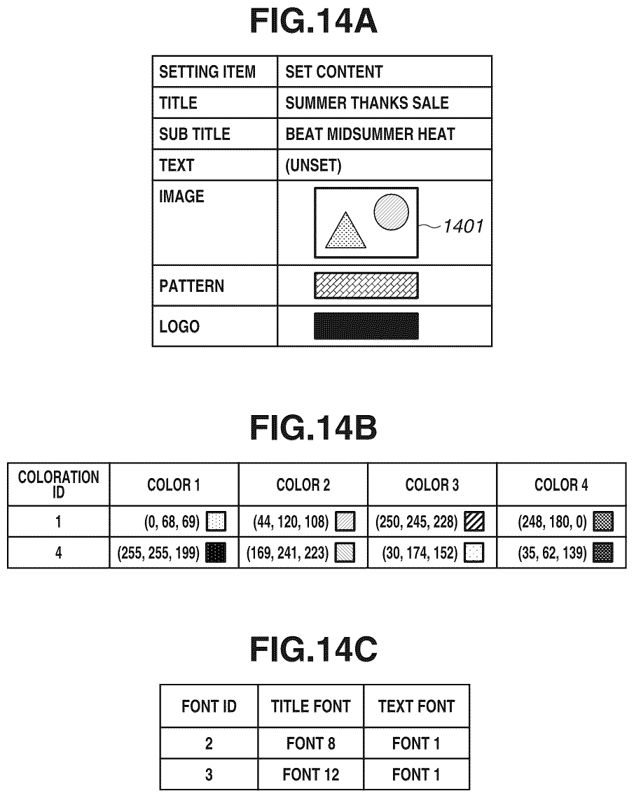

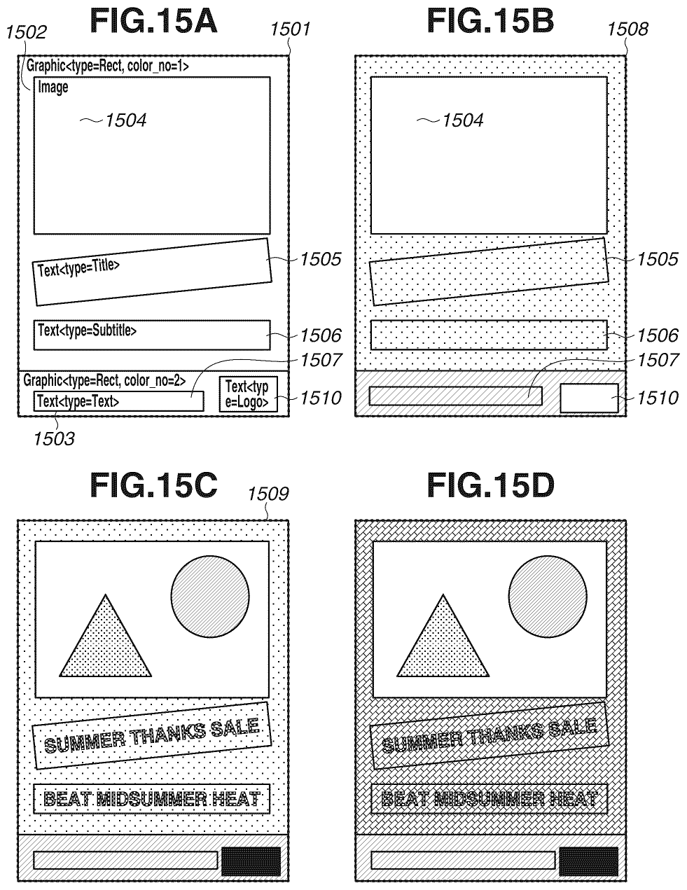

FIG. 12 is a software block diagram illustrating an example of the details of the layout unit 217. The layout unit 217 includes a coloration allocation unit 1201, an image arrangement unit 1202, an image correction unit 1203, a font setting unit 1204, a text arrangement unit 1205, a text decoration unit 1206, a pattern setting unit 1207, and a logo arrangement unit 1208. FIG. 13 is a flowchart illustrating the details of the processing in step S910. In addition, FIGS. 14A to 14C are diagrams illustrating information to be entered using the layout unit 217. FIG. 14A illustrates a table in which character information designated by the text designation unit 202 and images designated by the image designation unit 203 are organized. FIG. 14B illustrates an example of a table indicating coloration patterns acquired from the coloration pattern selection unit 215, and FIG. 14C illustrates an example of a table indicating fonts acquired from the font selection unit 216. FIGS. 15A to 15D are diagrams illustrating a process of the processing to be executed by the layout unit 217.

The processing in step S910 will be described in detail with reference to FIG. 13. The processing in steps S1301 to S1310 is a sub-procedure of the processing in step S910.

In step S1301, the layout unit 217 lists all combinations of skeletons acquired from the skeleton selection unit 214, coloration patterns acquired from the coloration pattern selection unit 215, and fonts acquired from the font selection unit 216. The layout unit 217 sequentially generates poster data through the subsequent layout processing on the combinations. For example, in a case where the number of skeletons acquired from the skeleton selection unit 214 is three, the number of coloration patterns acquired from the coloration pattern selection unit 215 is two, and the number of fonts acquired from the font selection unit 216 is two, the layout unit 217 generates 3×2×2=12 pieces of poster data. Next, in step S1301, the layout unit 217 selects one combination from among the listed combinations, and executes the processing in steps S1302 to S1307.

In step S1302, the coloration allocation unit 1201 allocates the coloration patterns acquired from the coloration pattern selection unit 215, to the skeletons acquired from the skeleton selection unit 214.

FIG. 15A is a diagram illustrating an example of a skeleton. In the present exemplary embodiment, the description will be given of an example in which the coloration pattern with the coloration ID 1 in FIG. 14B is allocated to a skeleton 1501 illustrated in FIG. 15A. The skeleton 1501 illustrated in FIG. 15A includes two graphic objects 1502 and 1503, one image object 1504, and three character objects 1505, 1506, and 1507. First of all, the coloration allocation unit 1201 performs coloration on the graphic objects 1502 and 1503. Specifically, the coloration allocation unit 1201 allocates corresponding colors from coloration patterns based on coloration numbers in metadata described in the graphic objects. Next, the coloration allocation unit 1201 allocates the last color in the coloration pattern, for example, to a character object of which the metadata indicates “type” and the attribute indicates “title”, among character objects. More specifically, in the present exemplary embodiment, the coloration allocation unit 1201 allocates a color 4 to characters to be arranged in the character object 1505. Next, the coloration allocation unit 1201 sets a character color for characters to be arranged in a character object of which the metadata indicates “type” and the attribute indicates an attribute other than “title”, among character objects, based on the brightness of the background of the character object. In the present exemplary embodiment, if the brightness of the background of the character object is equal to or smaller than a threshold value, the coloration allocation unit 1201 sets the character color to white. If not, the coloration allocation unit 1201 sets the character color to black. FIG. 15B is a diagram illustrating a state of a skeleton 1508 that has been subjected to the above-described coloration allocation processing. The coloration allocation unit 1201 outputs colored skeleton data to the image arrangement unit 1202.

In step S1303, the image arrangement unit 1202 arranges image data acquired from the image analysis unit 212, on a skeleton indicated by the skeleton data acquired from the coloration allocation unit 1201, based on accompanying analysis information. In the present exemplary embodiment, the image arrangement unit 1202 allocates image data 1401 to the image object 1504 in the skeleton. In a case where aspect ratios of the image object 1504 and the image data 1401 are different from each other, the image arrangement unit 1202 performs trimming to adapt the aspect ratio of the image data 1401 to the aspect ratio of the image object 1504. More specifically, based on the position of an object that is obtained by the image analysis unit 212 analyzing the image data 1401, the image arrangement unit 1202 performs trimming in such a manner that an object region to be reduced by the trimming becomes the minimum. The trimming method is not limited to this. For example, another trimming method, such as a method of trimming an image while leaving an image center, and a method of changing a composition in such a manner that a face position is arranged at the vertex of a triangle in a triangular composition, may be used. The image arrangement unit 1202 outputs the image-allocated skeleton data to the image correction unit 1203.

In step S1304, the image correction unit 1203 acquires the image-allocated skeleton data from the image arrangement unit 1202, and corrects the image arranged in the skeleton. In the present exemplary embodiment, in a case where the resolution of an image is insufficient, upsampling processing that is based on super-resolution processing is performed. First of all, the image correction unit 1203 determines whether the image arranged in the skeleton satisfies a certain resolution. For example, it is assumed that an image with 1600 px×1200 px is allocated to a region the size of 200 mm×150 mm on the skeleton. In this case, a print resolution of the image can be calculated using Formula 2.

$$\begin{matrix}[ Math . 1 ] & \\ \frac{1600}{200 \div 25.4} \approx 203 [ dpi ] & ( 1 )\end{matrix}$$

Next, in a case where it is determined that the print resolution of the image is smaller than the threshold value, the image correction unit 1203 increases the resolution through the super-resolution processing. On the other hand, in a case where it is determined that the print resolution of the image is equal to or larger than the threshold value and the resolution is sufficient, the image correction unit 1203 does not perform specific image correction. In the present exemplary embodiment, in a case where the print resolution of the image is smaller than 300 dots per inch (dpi), the image correction unit 1203 performs the super-resolution processing.

In step S1305, the font setting unit 1204 sets fonts acquired from the font selection unit 216, in the image-corrected skeleton data acquired from the image correction unit 1203. FIG. 14C illustrates an example of a combination of fonts selected by the font selection unit 216. In the present exemplary embodiment, the description will be given of an example of allocating a font in a case where a font to be allocated to the image-corrected skeleton data is a font with a font ID “2” in FIG. 14C. In the present exemplary embodiment, the font setting unit 1204 sets fonts for the character objects 1505, 1506, and 1507 in the skeleton 1508. In the case of posters, an easily-noticeable font is often set for a title from the viewpoint of noticeability, and a legible font is often set for other characters from the viewpoint of visibility. For this reason, in the present exemplary embodiment, the font selection unit 216 selects two types of fonts as a title font and a body text font. The font setting unit 1204 sets the title font for the character object 1505 of which the attribute indicates “title”, and sets the body text font for the other character objects 1506 and 1507. The font setting unit 1204 outputs the font-set skeleton data to the text arrangement unit 1205. In the present exemplary embodiment, the font selection unit 216 selects two types of fonts, but the number of fonts is not limited to this. For example, the font selection unit 216 may select only the title font. In this case, the font setting unit 1204 uses a font corresponding to the title font, as the body text font. In other words, the font setting unit 1204 is only required to set a body text font suitable for the type of title font. More specifically, it is sufficient that, if the font of a title is a Gothic font, the font setting unit 1204 selects a representative Gothic font with high readability for other characters, and if the font of a title is a Mincho font, the font setting unit 1204 selects a representative Mincho font for other characters. As a matter of course, a title font and a body text font may be set to the same font. Alternatively, a font may be flexibly used in accordance with a required eye-catching degree by using the title font for character objects with font sizes equal to or larger than a certain font size. For example, the title font may be used for character objects of which the attributes indicate title and sub title, and the body text font may be used for other character objects.

In step S1306, the text arrangement unit 1205 arranges a text designated by the text designation unit 202, in the skeleton indicated by the font-set skeleton data acquired from the font setting unit 1204. In the present exemplary embodiment, the text arrangement unit 1205 allocates each text illustrated in FIG. 14A, referring to the attribute in metadata of a character object in the skeleton. More specifically, the text arrangement unit 1205 allocates “summer thanks sale” of which the attribute indicates title, to the character object 1505, and allocates “beat midsummer heat” of which the attribute indicates sub title, to the character object 1506. Because a body text is not set, no text is allocated to the character object 1507. FIG. 15C illustrates a skeleton 1509 serving as an example of skeleton data processed by the text arrangement unit 1205. The text arrangement unit 1205 outputs the text-arranged skeleton data to the text decoration unit 1206.

In step S1307, the text decoration unit 1206 decorates character objects in the text-arranged skeleton acquired from the text arrangement unit 1205. In the present exemplary embodiment, if the color difference between a title character and the background region of the title character is equal to or smaller than a threshold value, the text decoration unit 1206 performs processing of bordering the title character. The readability of the title accordingly improves. The text decoration unit 1206 outputs the decorated skeleton data to the pattern setting unit 1207.

In step S1308, the pattern setting unit 1207 sets a pattern in the graphic object determined to be a background region in the text-decorated skeleton data acquired from the text decoration unit 1206. The graphic object determined to be a background region is a graphic object of which a coloration number is 1. In FIG. 15B, the pattern setting unit 1207 sets a pattern in the background region. When setting a pattern, after changing a color in accordance with the coloration allocated by the coloration allocation unit 1201, the pattern setting unit 1207 sets a pattern in the background region. FIG. 15D illustrates an example of the pattern-set skeleton. In a case where a pattern is not set by the multiple-promotional-material generation condition designation unit 201, a pattern set for skeleton data is set. The pattern setting unit 1207 outputs the pattern-set skeleton data to the logo arrangement unit 1208.

In step S1309, the logo arrangement unit 1208 arranges a logo in a logo object in the pattern-set skeleton data acquired from the pattern setting unit 1207. FIG. 15D illustrates an example of a logo-arranged skeleton. In a case where a logo is not set by the multiple-promotional-material generation condition designation unit 201, the processing in step S1309 is skipped. The logo arrangement unit 1208 outputs the logo-arranged skeleton data (i.e., layout-completed promotional material data) to the impression estimation unit 218.

In step S1310, the layout unit 217 determines whether all pieces of promotional material data have been generated. In a case where the layout unit 217 determines that processing target promotional materials have been generated using all skeletons, coloration patterns, combinations of fonts, patterns, and logos (YES in step S1310), the layout unit 217 ends the layout processing and advances the processing to step S911. In a case where the layout unit 217 determines that all pieces of promotional material data have not been generated (NO in step S1310), the processing returns to step S1301, and the layout unit 217 generates promotional material data using a combination that has not been used for generation.

The processing in step S910 has been described above. The description will return to the description of FIG. 9A.

In step S911, the impression estimation unit 218 estimates an impression of the promotional material data generated in step S910, and associates the estimated impression with the promotional material data. Specifically, the impression estimation unit 218 executes rendering processing on the promotional material data generated in step S910. Next, the impression estimation unit 218 estimates an impression of the rendered promotional material image. Lastly, the impression estimation unit 218 associates the estimated impression that has been estimated by itself, with the promotional material data. The rendering processing refers to processing of rendering promotional material data into image data. For example, a change in skeleton changes the arrangement even if its coloration pattern remains the same, so that a color to be actually used and an area in which the color is to be used vary in accordance with the change. For this reason, it is necessary to evaluate an impression of a final promotional material in addition to evaluation that is based on the tendencies of impressions of coloration patterns and skeletons. The processing is therefore executed at this timing. Thus, it is possible to evaluate an impression of a final promotional material in which images and characters are laid out, in addition to impressions of individual elements in the promotional material, such as coloration and arrangement.

In step S912, it is determined whether all promotional materials have been generated with respect to the number of promotional materials to be generated for one promotional material type determined in step S905. In the present exemplary embodiment, the number of promotional materials to be generated is five. In a case where the determined number of promotional materials has not been generated (NO in step S912), the processing returns to step S907, and a new promotional material is generated. In a case where the determined number of promotional materials has been generated (YES in step S912), the processing proceeds to step S914.

In step S913, it is determined whether all promotional materials have been generated with respect to the types of the promotional materials to be generated that have been determined in step S905. In the present exemplary embodiment, five promotional materials are to be generated for each of the three promotional material types. That is, 15 promotional materials in total are to be generated. In a case where the determined number of promotional materials has not been generated for all promotional material types (NO in step S913), after a target promotional material type is changed, the processing returns to step S906, and the determined number of promotional materials are generated for the newly-set promotional material type. In a case where all promotional material types of promotional materials has been generated (YES in step S913), the generation processing ends, and the processing proceeds to step S914.

In step S914, the design similarity degree calculation unit 219 calculates design similarity degrees of all patterns of promotional material sets obtained by combining all promotional materials acquired from the layout unit 217.

The processing in step S914 will be described in detail with reference to FIG. 9C. The processing in steps S931 to S937 is a sub-procedure of the processing in step S914.

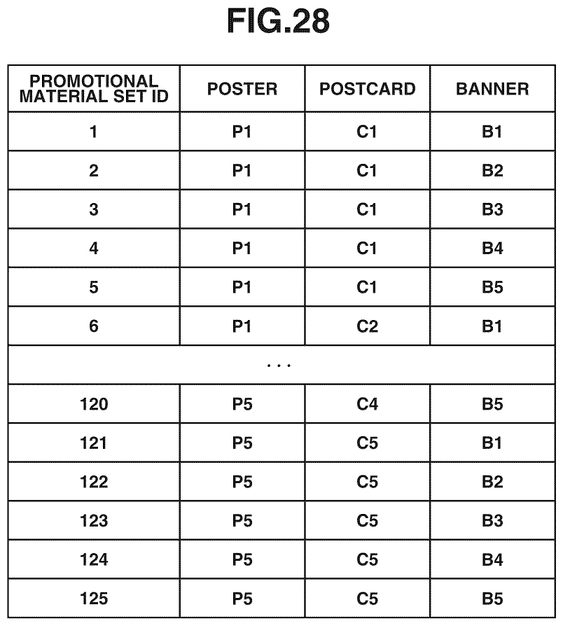

In step S931, the design similarity degree calculation unit 219 determine all possible combinations of promotional material sets based on the promotional materials generated by executing the processing in steps S906 to S913. Specifically, in the present exemplary embodiment, 15 promotional materials in total including five posters, five postcards, and five banners are generated in FIG. 5. The five promotional materials being the posters are denoted by Pn (n=integer from 1 to 5), the five promotional materials being the postcards are denoted by Cn (n=integer from 1 to 5), and the five promotional materials being the banners are denoted by Bn (n=integer from 1 to 5). In this case, there are 5×5×5=125 patterns of combinations of promotional material sets. FIG. 28 illustrates a table indicating combinations of promotional material sets according to the present exemplary embodiment.

The processing in steps S932 to S936 is repeated the number of times corresponding to the number of promotional material sets determined in step S931.

For the sake of simple description, a description will be given of a case where a promotional material set includes two promotional materials corresponding to a promotional material 1 and a promotional material 2. For example, the promotional material 1 is a poster and the promotional material 2 is a postcard.

In step S932, the design similarity degree calculation unit 219 calculates a coloration similarity degree. As the coloration similarity degree, the design similarity degree calculation unit 219 calculates a degree to which used colors are similar. A smaller value of the coloration similarity degree indicates more similar colors. Specifically, the coloration similarity degree is calculated based on a distance ΔE in the CIE L*A*B*color space of combinations of used coloration patterns. It is assumed that coloration patterns used in the promotional material 1 correspond to coloration patterns 1 and 2, and coloration patterns used in the promotional material 2 correspond to coloration patterns 3 and 4. In this case, the design similarity degree calculation unit 219 calculates, as the coloration similarity degree, total values of the distances ΔE in the CIEL*A*B*color space between the coloration patterns 1 and 3, between the coloration patterns 1 and 4, between the coloration patterns 2 and 3, and between the coloration patterns 2 and 4. Alternatively, the design similarity degree calculation unit 219 may calculate the coloration similarity degree using, as a weight, the percentage of the area of each coloration pattern with respect to the total area of a promotional material. In this case, the design similarity degree calculation unit 219 calculates areas using the promotional materials 1 and 2 rendered by executing rendering processing on the promotional materials 1 and 2. In the calculation formula of a coloration similarity degree Mc to be calculated in this case, a percentage of the coloration pattern 1 with respect to the total area of the promotional material 1 is denoted by We1, a percentage of the coloration pattern 2 with respect to the total area of the promotional material 1 is denoted by Wc2, a percentage of the coloration pattern 3 with respect to the total area of the promotional material 2 is denoted by Wc3, and a percentage of the coloration pattern 4 with respect to the total area of the promotional material 2 is denoted by Wc4. If ΔE between the coloration patterns 1 and 3 is denoted by ΔE13, ΔE between the coloration patterns 1 and 4 is denoted by ΔE14, ΔE between the coloration patterns 2 and 3 is denoted by ΔE23, and ΔE between the coloration patterns 2 and 4 is denoted by ΔE14, the coloration similarity degree Mc can be represented as follows.

$$Mc = Wc 1 \times Wc 3 \times Δ E 13 + Wc 1 \times Wc 4 \times Δ E 14 + Wc 2 \times Wc 3 \times Δ E23 + Wc 2 \times Wc 4 \times Δ E 24$$

For example, it is assumed that a percentage of the coloration pattern 1 with respect to the total area of the promotional material 1 is 0.5, a percentage of the coloration pattern 2 with respect to the total area of the promotional material 1 is 0.1, a percentage of the coloration pattern 3 with respect to the total area of the promotional material 2 is 0.3, and a percentage of the coloration pattern 4 with respect to the total area of the promotional material 2 is 0.2. It is assumed that ΔE between the coloration patterns 1 and 3 is 1, ΔE between the coloration patterns 1 and 4 is 2, ΔE between the coloration patterns 2 and 3 is 3, and ΔE between the coloration patterns 2 and 4 is 4. A coloration similarity degree obtained in this case is 0.52.

In step S933, the design similarity degree calculation unit 219 calculates a pattern similarity degree. As the pattern similarity degree, the design similarity degree calculation unit 219 calculates a degree to which shapes of patterns used in promotional materials are similar. A smaller value of the pattern similarity degree indicates more similar patterns. Specifically, the design similarity degree calculation unit 219 calculates the pattern similarity degree based on a similarity degree of silhouettes of patterns. It is sufficient that a known method is used as the calculation method. For example, the design similarity degree calculation unit 219 generates silhouette images by applying an edge extraction filter to pattern images of the same size clipped out in.

By superimposing extracted silhouette images, the design similarity degree calculation unit 219 calculates the number of pixels being edge pixels as both patterns. The design similarity degree calculation unit 219 calculates, as the pattern similarity degree, a percentage of the number of pixels being edge pixels as both patterns, with respect to the total number of pixels of the pattern images. In a case where a pattern is not used in one of the promotional materials, the pattern similarity degree is the maximum value, and the pattern images are determined to be inconsistent. In a case where patterns are used in both promotional materials, the pattern similarity degree is zero, and the pattern images are determined to be consistent.

In step S934, the design similarity degree calculation unit 219 calculates a logo similarity degree. As the logo similarity degree, the design similarity degree calculation unit 219 calculates a degree to which shapes and colors of logos used in promotional materials are similar. A smaller value of the logo similarity degree indicates more similar logos. The design similarity degree calculation unit 219 calculates a logo shape similarity degree by performing the processing similar to the processing in step S932. The design similarity degree calculation unit 219 calculates a logo color similarity degree based on a color difference ΔE of colors of the largest areas in the logos. The design similarity degree calculation unit 219 calculates a total value of the logo shape similarity degree and the logo color similarity degree as the logo similarity degree.

In step S935, the design similarity degree calculation unit 219 calculates a font similarity degree. As the font similarity degree, the design similarity degree calculation unit 219 calculates a degree to which shapes and colors of fonts used in promotional materials are similar. A smaller value of the font similarity degree indicates more similar fonts. The design similarity degree calculation unit 219 calculates a font shape similarity degree by performing the processing similar to the processing in step S932 on character images obtained by rendering the same text. Alternatively, the design similarity degree calculation unit 219 may calculate a font shape similarity degree based on fonts classified by type. For example, there are serif and sans-serif as the types of fonts for alphabets. If both fonts used in promotional materials are serif or sans-serif, the font similarity degree is zero, and the fonts are determined to be consistent. In a case where fonts used in promotional materials are different fonts (i.e., serif and sans-serif), the font similarity degree is the maximum value, and the fonts are determined to be inconsistent. Alternatively, the design similarity degree calculation unit 219 may calculate a font shape similarity degree based on a difference in font thickness. For example, a similarity degree of fonts with thicknesses 1 and 2 is 1.

In step S936, the design similarity degree calculation unit 219 performs comprehensive evaluation based on the similarity degrees calculated in steps S931 to S935, and calculates a total similarity degree. The calculated total similarity degree is associated with the corresponding promotional material set and stored into the RAM 103. A value range varies depending on the similarity degree, and similarity degrees of all the promotional material sets are standardized. The total value of standardized similarity degrees is calculated as the total similarity degree. In addition, the total value may be calculated after adding a weight to each similarity degree. This is because, when design similarity is recognized, colors and shapes have strong impacts and fonts and logos have weak impacts. For this reason, increasing the weights of a coloration similarity degree and a pattern similarity degree and decreasing the weights of a logo similarity degree and a font similarity degree allows simulation of evaluation of a person recognizing that the promotional materials have the same design. As a weight determination method, a weight can be calculated by subjective assessment.

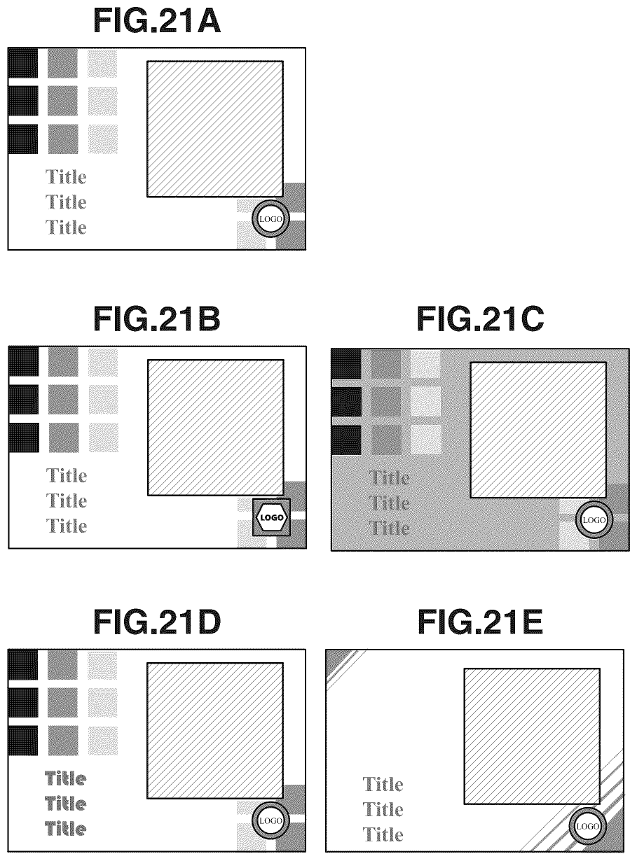

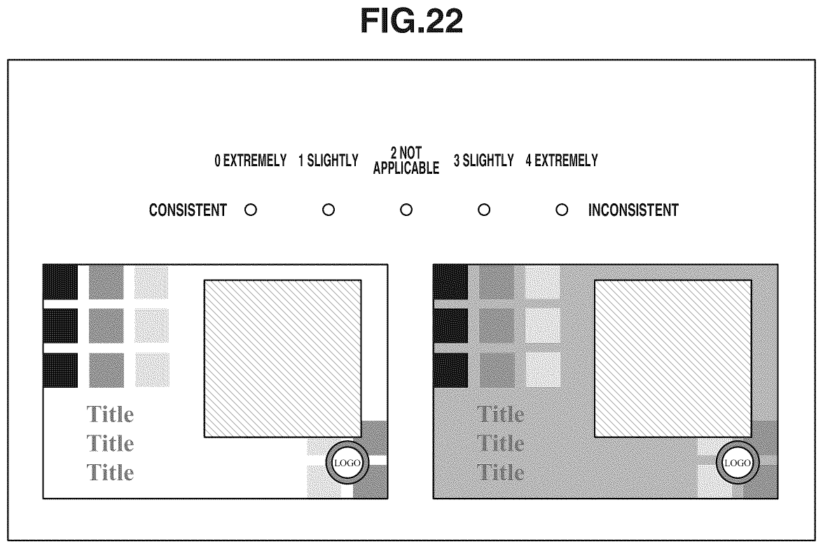

FIGS. 21A to 21E and 22 are diagrams illustrating subjective assessment of determining weights of design elements in calculating a design similarity degree. For example, a promotional material serving as one standard is generated as illustrated in FIG. 21A. A promotional material in which only one design element is changed with respect to the standard promotional material is generated. For example, a promotional material in which only a logo is changed as illustrated in FIG. 21B, a promotional material in which only coloration is changed as illustrated in FIG. 21C, a promotional material in which only a font is changed as illustrated in FIG. 21D, and a promotional material in which only a pattern is changed as illustrated in FIG. 21E are generated. The subjective assessment for determining a degree to which each changed promotional material is consistent with the standard promotional material is performed. For example, evaluation values from 5 (extremely inconsistent) to 0 (extremely consistent) as illustrated in FIG. 22 are set, and subjective assessment of comparing the standard promotional material and the promotional material with the different coloration is performed on a plurality of test subjects. The same subjective assessment is performed for the promotional material with the different pattern, the promotional material with the different logo, and the promotional material with the different font. An average value of the values obtained from the plurality of test subjects is calculated. A large average value indicates that the promotional materials are evaluated to be dissimilar, so that it can be estimated that even a sight difference easily leads to determination made that designs are dissimilar. Thus, a weight is increased in the calculation of a design similarity degree. A small average value indicates that the promotional materials are similar, so that it can be estimated that a sight difference easily leads to determination made that designs are similar. Thus, a weight is decreased in the calculation of a design similarity degree. As a specific weight calculation method, by setting the total value of average values of similarity degrees to 1, the percentage of the average value of each similarity degree is calculated. This allows appropriate generation of a plurality of promotional materials with a uniform design. The above-described description has been given of the case where a promotional material set includes two promotional materials, so that only one design similarity degree is calculated. In a case where a promotional material set includes three or more promotional materials, in which there are multiple combinations each including two promotional materials, a plurality of design similarity degrees are calculated. Specifically, in a case where a promotional material set includes promotional materials 1, 2, and 3, three design similarity degrees, i.e., a design similarity degree between the promotional materials 1 and 2, a design similarity degree between the promotional materials 2 and 3, and a design similarity degree between the promotional materials 3 and 2, are calculated. In a case where a promotional material set includes three or more promotional materials, the design similarity degree calculation unit 219 calculates a total value of a plurality of design similarity degrees as a design similarity degree of the promotional material set. The design similarity degree calculation unit 219 stores the calculated design similarity degree in association with promotional material data.

The processing in step S914 has been described above. The description will return to the description of FIG. 9A.

In step S915, the multiple-promotional-material selection unit 220 selects a promotional material set to be output to the display 105 (to be presented to the user), based on the estimated impression acquired from the impression estimation unit 218, and the design similarity degree acquired from the design similarity degree calculation unit 219. Specifically, first of all, the multiple-promotional-material selection unit 220 calculates the impression distance between the estimated impression and the target impression that are associated with promotional material data. The calculated impression distance is stored in association with the promotional material data. In the present exemplary embodiment, 15 promotional materials are generated, so that 15 impression distances are calculated. A Euclidean distance is used as an impression distance. A smaller value of the Euclidean distance indicates a closer distance between the target impression and the estimated impression. The distance to be calculated by the multiple-promotional-material selection unit 220 is not limited to the Euclidean distance. any calculation may be used if a distance between vectors, such as a Manhattan distance and a cosine similarity degree can be calculated. Next, the multiple-promotional-material selection unit 220 calculates a total impression distance for each promotional material set. In the present exemplary embodiment, one promotional material set includes three types of promotional materials corresponding to poster, postcard, and banner. By adding up the three calculated impression distances, the multiple-promotional-material selection unit 220 calculates the total impression distance. The calculated total impression distance is stored in association with the promotional material set. Next, the multiple-promotional-material selection unit 220 calculates a total value of the total impression distance and a design similarity degrees that are associated with the promotional material set. The multiple-promotional-material selection unit 220 selects a promotional material set based on the calculated total value. In the present exemplary embodiment, one promotional material set is displayed on the multiple-promotional-material preview screen 601 illustrated in FIG. 6, so that a promotional material set with the smallest total value is selected. In a case where a plurality of promotional material sets is displayed on the multiple-promotional-material preview screen 601, promotional material sets with smaller total values are selected up to a maximum number of promotional materials sets that can be displayed on the multiple-promotional-material preview screen 60. In addition, a promotional material set with a total value equal to or smaller than a predetermined threshold value may be selected. In this case, in a case where the number of selected promotional material sets is not reached to a maximum number of promotional material sets that can be displayed on the multiple-promotional-material preview screen 601, the processing may return to step S907, and different promotional material data may be generated. Which of the impression distance and the design similarity degree is to be prioritized is determined based on a reflection degree of brand information that is designated by the multiple-promotional-material generation condition designation unit 201. By applying weights when adding up the total impression distance and the design similarity degree, which of the impression distance and the design similarity degree is to be prioritized can be determined based on the reflection degree. For example, in a case where the reflection degree is 0.4 as displayed on the application activation screen 501 illustrated in FIG. 5, a total value is calculated by setting the weight of the impression distance to 0.6 and the weight of the design similarity degree to 0.4. The user can thereby adjust the priority of the design similarity degree using the reflection degree slider bar 520 on the application activation screen 501. Furthermore, it is possible to automatically generate a promotional material intended by the user.

In step S916, the multiple-promotional-material display unit 205 displays the multiple-promotional-material preview screen 601 illustrated in FIG. 6.

Specifically, in step S915, the multiple-promotional-material display unit 205 renders a plurality of pieces of promotional material data included in the promotional material set selected by the multiple-promotional-material selection unit 220, and outputs the plurality of pieces of promotional material data to the display 105.

The procedure of poster generation processing of generating a poster by the user designating an impression has been described above.

As described above, according to the present exemplary embodiment, a promotional material representing an impression that is uniform and is intended by the user can be automatically generated for a plurality of promotional materials. More specifically, in the present exemplary embodiment, to generate a design representing an impression of a brand that is intended by the user, in each promotional material, elements included in a promotional material, such as a skeleton, a coloration pattern, and a font, are combined based on a target impression. Furthermore, estimating an impression of the entire promotional material and selecting a promotional material close to the target impression from among one or a plurality of poster candidates allows generation of a promotional material of which the impression intended by the user is given not only as a single element but also as a whole. Furthermore, to generate a uniform design, calculating a design similarity degree between promotional materials allows selection of a design with high similarity degrees of design elements. Specifically, design similarity degrees are calculated for logo, font, pattern, and color, all of which are design elements.

### Modified Example of First Exemplary Embodiment

In the first exemplary embodiment, a generated promotional material set is displayed on the multiple-promotional-material preview screen 601, but a target impression and brand information may be set on a preview screen.

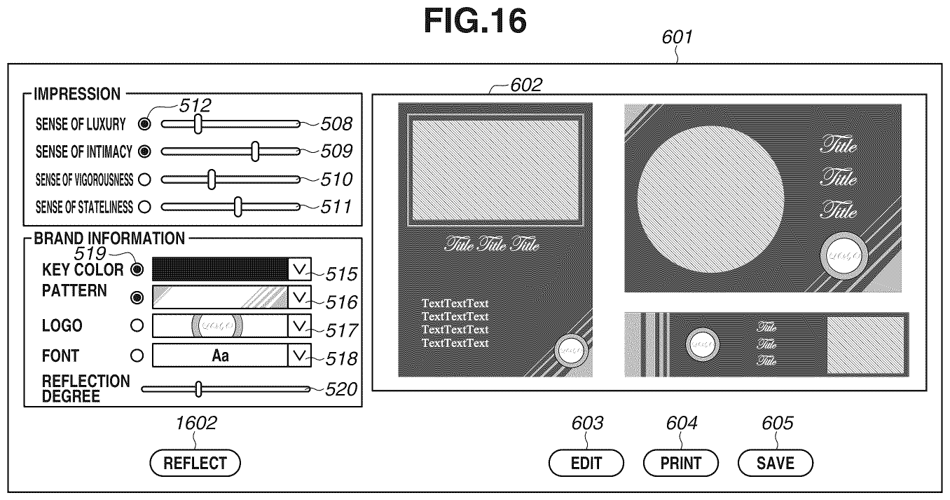

FIG. 16 is a diagram illustrating an example of a UI for setting a target impression and brand information on a preview screen 601. The components denoted by the same reference numerals as those in FIG. 5 perform the same operations as those described with reference to FIG. 5. The components denoted by the same reference numerals as those in FIG. 6 perform the same operations as those described with reference to FIG. 6. The multiple-promotional-material display unit 205 displays the preview screen 601 in step S916. On the preview screen 601, the impression sliders 508 to 511 and the impression enabling radio button 512 on the application activation screen 501 are arranged as a UI for setting a target impression. Furthermore, as a UI for setting brand information, the key color designation box 515, the pattern designation box 516, the logo designation box 517, the font designation box 518, and the reflection degree slider bar 520 are arranged. Furthermore, a reflection button 1602 for reflecting set information is arranged on the preview screen 601. The user changes a target impression and brand information while checking the preview image 601.

Then, in response to a press of the reflection button 1602, the processing proceeds to step S902, and the processing in steps S902 to S916 is executed. As a processing execution result, the multiple-promotional-material display unit 205 displays the preview image 601 on which the settings for the target impression and the brand information set on the preview screen 601 are reflected. This configuration allows setting of a target impression and brand information while checking a generation result of a promotional material set. Consequently, a design representing an impression of a brand that is uniform and is intended by the user can be automatically generated without involving troublesome screen transition.

In the first exemplary embodiment, the settings of a target impression and brand information are made on the application activation screen 501. However, in a case where a user is unfamiliar with impressions and brands, it is difficult for the user to set an impression and brand information on the application activation screen 501. The user would repeatedly make settings while viewing generation results of a promotional material, which is a troublesome operation. In the present exemplary embodiment, based on a generation result of one promotional material, a target impression and brand information may be reflected on a different promotional material. Specifically, for one promotional material type, a plurality of promotional materials in which various impressions and brands are reflected are displayed, and a promotional material is selected from among the promotional materials. Then, a target impression and brand information are acquired from the selected promotional material, and a promotional material of a different promotional material type is generated. This configuration allows automatic generation of a design that represents an impression of a brand that is uniform and is intended by a user without repeatedly making settings even if the user is unfamiliar with impressions and brands.

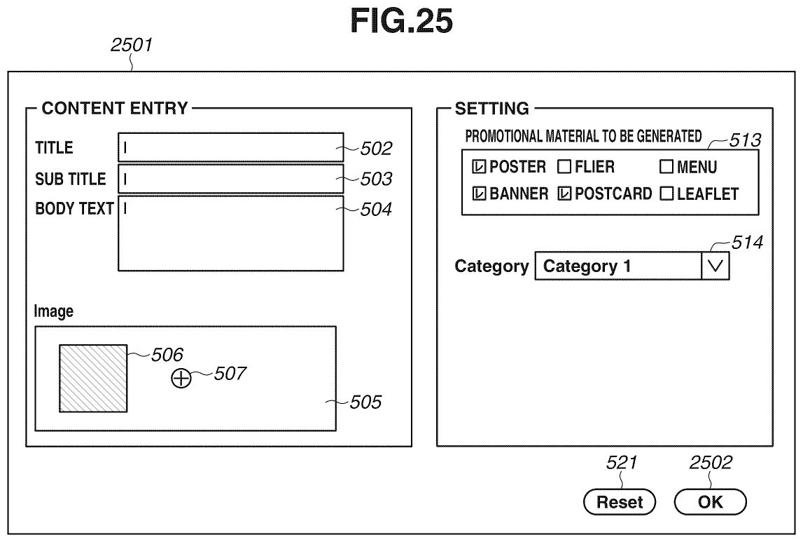

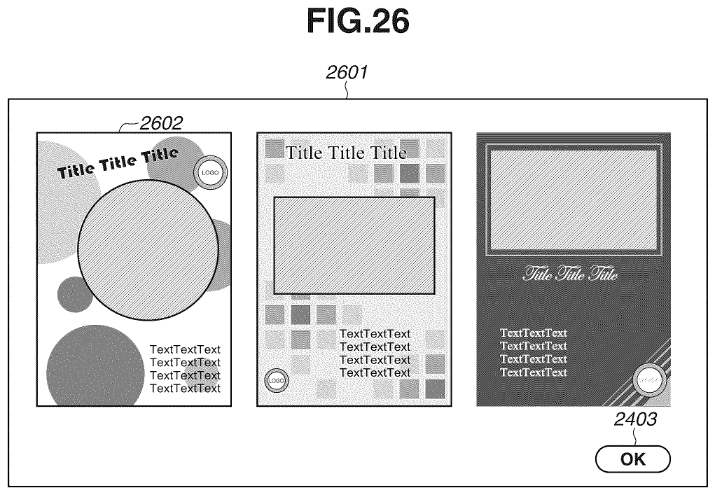

FIG. 25 is a diagram illustrating an example of an application activation screen 2501 to be provided by the multiple-promotional-material generation application according to the present exemplary embodiment. The components denoted by the same reference numerals as those in FIG. 5 perform the same operations as those described with reference to FIG. 5. As illustrated in FIG. 25, as compared with the application activation screen 501, UIs for setting an impression and brand information are not provided. If an OK button 2502 is pressed, various promotional materials with different target impressions and different brand information are generated for the top-left promotional material type among promotional material types selected in the generated promotional material designation region 513. If the promotional materials are generated, the multiple-promotional-material display unit 205 displays the generated promotional materials on a preview screen 2601. As an example, in the present exemplary embodiment, various generated poster promotional materials are displayed. Next, from among poster promotional materials displayed in a promotional material image 2602, a poster that meets the intention of the user is selected. If an OK button 2403 is pressed after the selection, a target impression and brand information are acquired from the selected poster promotional material, and a promotional material of a different promotional material type is generated. If the promotional material of the different promotional material type is generated, the preview screen 2601 transitions to the multiple-promotional-material preview screen 601 illustrated in FIG. 6. In the present exemplary embodiment, a promotional material set preview-displayed on the multiple-promotional-material preview screen 601 illustrated in FIG. 6 as an example indicates that the rightmost poster among posters displayed on the preview screen 2601 in FIG. 26 is selected.

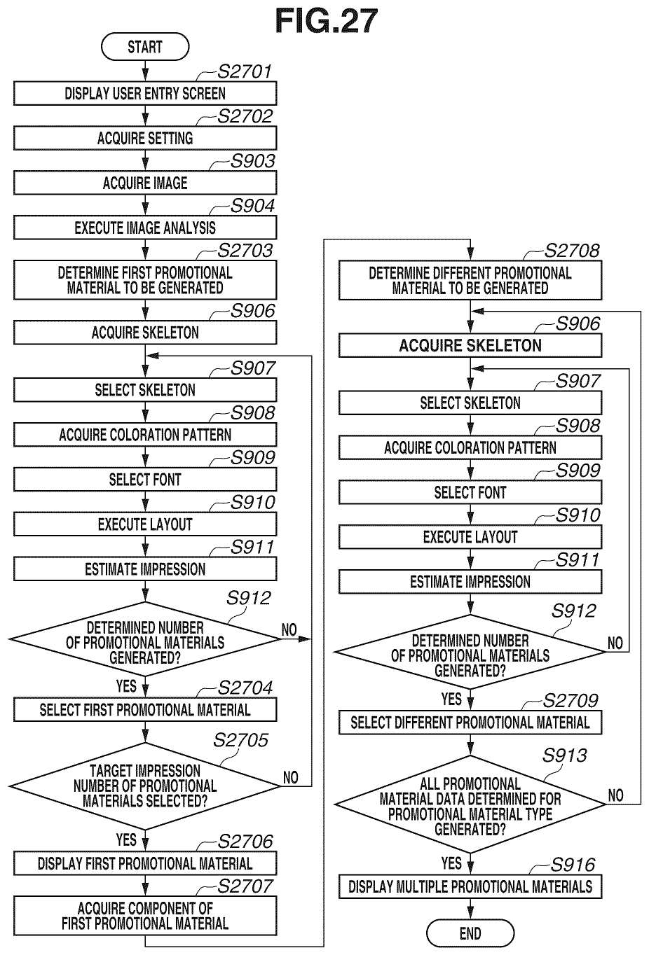

FIG. 27 is a flowchart illustrating generation processing of a plurality of promotional materials according to the present exemplary embodiment. In the processing in this flowchart, the pieces of processing with the same step reference numerals as those of the flowchart in FIG. 9A are the same as those described in the first exemplary embodiment, and the description thereof will be omitted. In the processing in this flowchart, steps S901, S902, S905, S914, and S915 illustrated in FIG. 9A are omitted.

In step S2701, the multiple-promotional-material generation application displays the application activation screen 2501 on the display 105. The user enters settings via the UI screen on the application activation screen 2501 using the keyboard 106 and the pointing device 107.

In step S2702, the multiple-promotional-material generation condition designation unit 201, the text designation unit 202, and the image designation unit 203 acquire corresponding settings from the application activation screen 2501. The text designation unit 202 and the image designation unit 203 acquire the settings by executing processing similar to the processing in step S902. The multiple-promotional-material generation condition designation unit 201 acquires a type and a category of a promotional material to be generated, by executing processing similar to the processing in step S902.

In step S2703, the processing determines a first type of promotional materials to be generated in variations and to be displayed on the preview screen 2601, and a target impression to be generated. As a first promotional material type, the type of a promotional material is selected that is displayed at the top-left position among promotional materials selected by the multiple-promotional-material generation condition designation unit 201. In the present exemplary embodiment, a poster is selected. In addition, the promotional material type may be changed to a promotional material type for which the user can check the impression and the brand information. For example, a promotional material including a logo, a font, coloration, and a pattern, which serve as an example of brand information, as design elements is desirably selected. Next, to generate various promotional materials, the target impression designation unit 204 discretely determines a plurality of target impression values. As an example, the target impression designation unit 204 may prepare three patterns of target impression values, such as a sense of vigorousness +2 (the other impression values are zero), a sense of vigorousness −2 (the other impression values are zero), and a sense of luxury +2 (the other impression values are zero). To generate various promotional materials, it is desirable that target impression values are away from each other on an impression space. Furthermore, a number predetermined for one target impression is determined to be the number of promotional materials to be generated. In the present exemplary embodiment, as an example, the predetermined number is set to five. More specifically, in the present exemplary embodiment, five poster promotional materials are generated for the three target impressions. In the present exemplary embodiment, through the processing in steps S907 to S912, five poster promotional materials with one target impression are generated.

In step S2704, the multiple-promotional-material selection unit 220 selects one promotional material from among a plurality of promotional materials generated for the one target impression, based on the estimated impression acquired from the impression estimation unit 218. Specifically, first of all, similarly to step S915, the multiple-promotional-material selection unit 220 calculates the impression distance between the estimated impression and the target impression that are associated with promotional material data. Next, the multiple-promotional-material selection unit 220 selects a promotional material with the smallest impression distance. The selected promotional material is stored in the RAM 103. The selected promotional material is displayed on the preview screen 2601 in step S2706 to be described below.

In step S2705, the processing determines whether the number of the promotional materials that are selected in step S2704 is the same as the number of target impressions determined in step S2703. In the present exemplary embodiment, the number of determined target impressions is three. In a case where the number of the promotional materials that are selected in step S2704 is not the same as the number of target impressions (NO in step S2705), the target impression designation unit 204 changes the target impression to the next target impression, and returns the processing to step S907. In a case where the number of the promotional materials that are selected in step S2704 is the same as the number of target impressions (YES in step S2705), the processing proceeds to step S2705.

In step S2706, the promotional materials selected in step S2704 are displayed on the preview screen 2601, and the user is prompted to select one from among the displayed promotional materials promotional materials. The promotional material selected by the user is stored in the RAM 103.

In step S2707, a target impression and brand information are acquired from the promotional material selected by the user in step S2706. The target impression to be acquired is the estimated impression associated with the promotional material selected by the user. The brand information to be acquired is at least one of a logo, coloration, a font, and a pattern included in the promotional material selected by the user. If no promotional material includes a logo, coloration, a font, or a pattern, brand information about the promotional material is not acquired. This configuration makes it possible to make at least one of a logo, coloration, a font, and a pattern common to skeletons of different promotional materials.

In step S2708, based on the settings acquired in step S2702, and on the target impression and brand information acquired in step S2707, a promotional material of a promotional material type different from the first promotional material type is determined to be a type of a promotional material to be generated. As an example, in FIG. 25, the types different from the first promotional material type correspond to two types, i.e., postcard and banner. Furthermore, a number predetermined for one promotional material type is determined to be the number of promotional materials to be generated. In the present exemplary embodiment, the predetermined number is five. Through the processing in steps S906 to S912, five promotional materials are generated for one promotional material type.

In step S2709, the multiple-promotional-material selection unit 220 selects one promotional material from a plurality of promotional materials generated for one promotional material type, based on the estimated impression acquired from the impression estimation unit 218. Specifically, first of all, similarly to step S915, the multiple-promotional-material selection unit 220 calculates the impression distance between the estimated impression and the target impression that are associated with promotional material data. Next, the multiple-promotional-material selection unit 220 selects a promotional material with the smallest impression distance. The selected promotional material is stored in the RAM 103. The selected promotional material is displayed on the multiple-promotional-material preview screen 601 in step S916. Through the processing in step S913, promotional materials the number of which is the same as the number of promotional material types determined in step S2708 can be generated.

With this configuration, even a user who is unfamiliar with impressions and brands can automatically set an impression and brand information by selecting a generated promotional material. Consequently, a design that represents an impression of a brand that is uniform and is intended by the user can be automatically generated without performing a troublesome repetitive operation.

A second exemplary embodiment will be described. In the first exemplary embodiment, the description has been given of the example of generating a design with a high similarity degree of design elements by generating a promotional material by selecting a skeleton, a coloration pattern, and a font, which are components of the promotional material, based on a target impression, and further calculating a design similarity degree between promotional materials. In the second exemplary embodiment, a combination generation unit searches for a combination of components of a promotional material that makes the impression of the entire poster closer to a target impression, and a combination of design elements that makes a design similarly degree higher, based on a genetic algorithm. This configuration makes it possible to select components of a promotional material that are the most appropriate for the target impression, and design elements with a high design similarly degree more flexibly without performing pre-calculation to prepare the skeleton impression table, the coloration pattern impression table, and the font impression table.

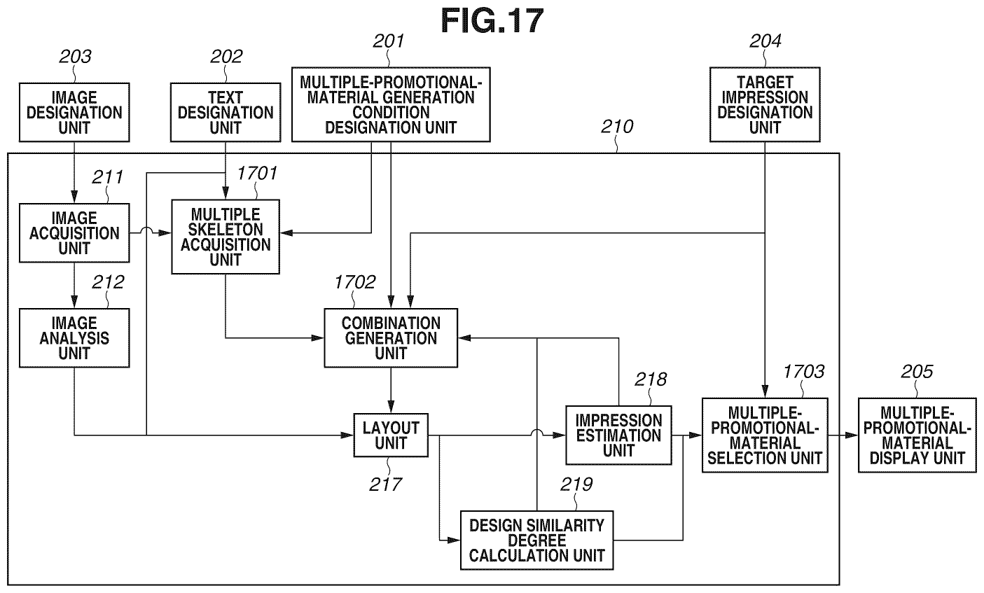

FIG. 17 is a software block diagram is a software block diagram of a multiple-promotional-material generation application according to the second exemplary embodiment. In the configuration of the block diagram illustrated in FIG. 17, a combination generation unit 1702 is included in place of the skeleton selection unit 214, the coloration pattern selection unit 215, and the font selection unit 216 in FIG. 2. The components with the same reference numerals as those in FIG. 2 execute the same processing at that described in the first exemplary embodiment, and the description thereof will be omitted.

A multiple skeleton acquisition unit 1701 acquires skeletons the number of which is the same as the number of promotional material types designated by the multiple-promotional-material generation condition designation unit 201. To use a search algorithm, the multiple skeleton acquisition unit 1701 acquires all of the skeletons the number of which is the same as the designated number of promotional material types, and stores the acquired skeletons in the RAM 103.

The combination generation unit 1702 acquires one or more skeletons from the multiple skeleton acquisition unit 1701, the number of the skeletons being the same as the number of promotional material types, and acquires promotional material data and estimated promotional material impression from the impression estimation unit 218. The combination generation unit 1702 acquires a target impression from the target impression designation unit 204, and acquires a design similarity degree between promotional materials from the design similarity degree calculation unit 219. Furthermore, the combination generation unit 1702 acquires a coloration pattern list, a font list, and a pattern list from the HDD 104. Furthermore, the combination generation unit 1702 generates combinations of components (skeleton, coloration pattern, font) of a promotional material, and design elements (logo, pattern), which are to be used for promotional material generation, the number of the combinations corresponding to the number of promotional material types. As an example, in the present exemplary embodiment, combinations of three types corresponding to poster, postcard, and banner are generated. One combination including these promotional material types is defined as one promotional material set combination. The combination generation unit 1702 outputs the generated promotional material set combination to the layout unit 217.

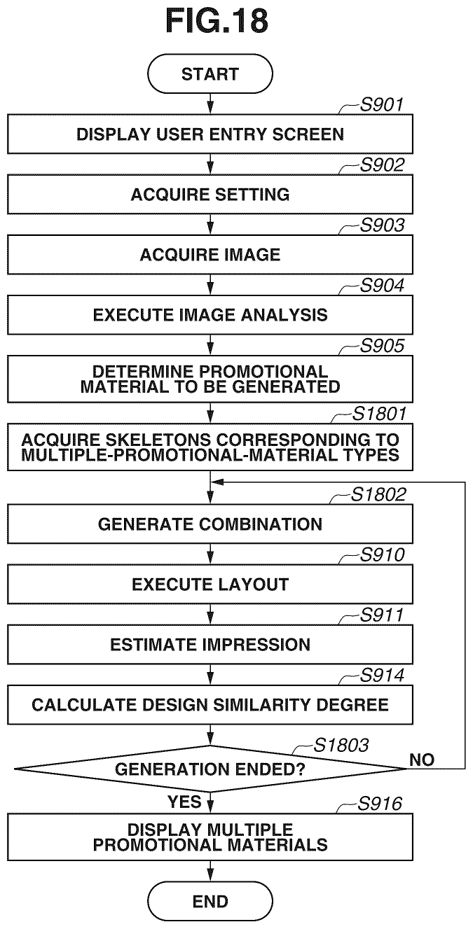

FIG. 18 is a flowchart illustrating processing to be executed by the multiple-promotional-material generation unit 210 of the multiple-promotional-material generation application according to the present exemplary embodiment. In the processing in this flowchart, the pieces of processing with the same step reference numerals as those of the flowchart in FIG. 9A are the same as those described in the first exemplary embodiment, and the description thereof will be omitted. In the processing in this flowchart, steps S906 to S909 and S911 illustrated in FIG. 9A are omitted.

In step S1801, the multiple skeleton acquisition unit 1701 acquires skeletons the number of which is the same as the number of promotional material types designated by the multiple-promotional-material generation condition designation unit 201. Specifically, the multiple skeleton acquisition unit 1701 repeats the processing in steps S921 to S926 of FIG. 9B the number of times corresponding to the designated number of promotional material types. To use a search algorithm, the multiple skeleton acquisition unit 1701 acquires all of the skeletons the number of which is the same as the designated number of promotional material types. As an example, in FIG. 5, the multiple skeleton acquisition unit 1701 acquires all skeletons of poster, postcard, and banner.

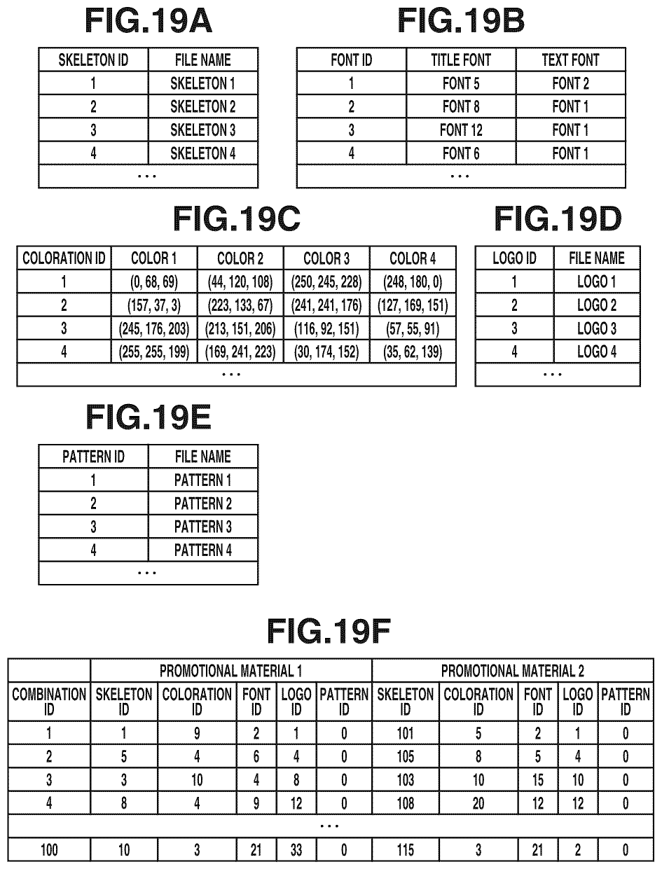

In the description of step S1802, an operation to be performed when the processing is executed for the first time, and an operation to be performed in second and subsequent loops will be separately described. First of all, when the processing in step S1802 is executed for the first time, the combination generation unit 1702 acquires tables of skeletons, coloration patterns, fonts, logos, and patterns that are to be used for promotional material generation. FIGS. 19A to 19F are diagrams illustrating tables to be used by the combination generation unit 1702. FIG. 19A illustrates a list of skeletons acquired by the combination generation unit 1702 from the multiple skeleton acquisition unit 1701. FIGS. 19B, 19C, 19D and 19E respectively illustrate a font list, a coloration list, a logo list, and a pattern list that are acquired by the combination generation unit 1702 from the HDD 104. The combination generation unit 1702 generates random-combination designated promotional materials the number of which is the same as the number of promotional material types from the above-described five tables. In the present exemplary embodiment, the combination generation unit 1702 generates 100 promotional material set combinations. FIG. 19F illustrates a table indicating promotional material set combinations generated in the present exemplary embodiment. In a case where brand information is designated by the multiple-promotional-material generation condition designation unit 201, the setting is made in such a manner that the same ID is used between promotional materials. FIG. 19F illustrates a table indicating combinations generated when a pattern is designated as brand information. The same pattern ID is set in both the promotional materials 1 and 2. Furthermore, in a case where a reflection degree of brand information is designated by the multiple-promotional-material generation condition designation unit 201, a percentage at which the same pattern ID is set in both the promotional materials 1 and 2 is determined based on a setting value of the reflection degree. Specifically, in a case where 0.3 is designated as the reflection degree of brand information, out of the 100 combinations, 30 combinations have the same ID and the remaining 70 combinations become random combinations. After that, the combination generation unit 1702 executes the processing in steps S910, S911, S914, and S1803 on all the generated combinations.

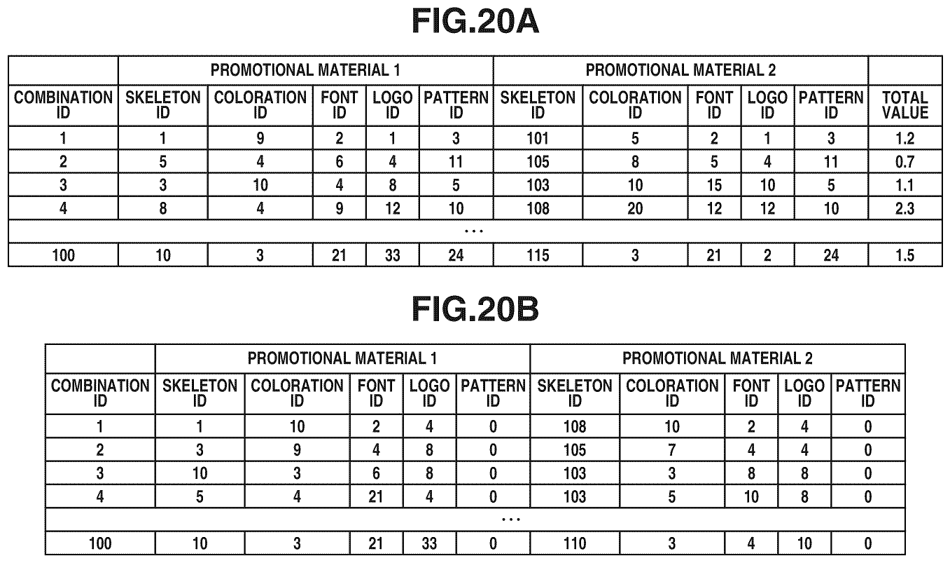

Next, in the second and subsequent loops of step S1802, the combination generation unit 1702 calculates an evaluation value from the estimated impression acquired from the impression estimation unit 218, and the design similarity degree acquired from the design similarity degree calculation unit 219, and associates the calculated evaluation value with the promotional material set combination table. The calculation method for the evaluation value is similar to the calculation method for the total value of the total impression distance and the design similarity degree that is used in step S915. FIGS. 20A and 20B are diagrams illustrating an operation to be performed in the second and subsequent loops of step S1802. FIG. 20A illustrates a table associating the above-described evaluation value with the table illustrated in FIG. 19D. An evaluation value column in FIG. 20A indicates an evaluation value of a promotional material set generated based on a combination on a corresponding row. The combination generation unit 1702 generates a new combination table from the table in FIG. 20A. FIG. 20B illustrates a newly-generated combination table. In the present exemplary embodiment, a new combination is generated using tournament selection and uniform crossover in the genetic algorithm. First of all, N combinations are selected at random from the table in FIG. 20A. For example, N=3 is set. Next, from among the selected combinations, top two combinations with small evaluation values (=close to the target impression and a design similarity degree is high) are selected. Lastly, a new combination is generated by randomly changing elements (skeleton ID, coloration ID, font ID, logo ID, pattern ID) of the selected two combinations. For example, combinations with combination IDs 1 and 2 in FIG. 20B are combinations generated from combinations with combination IDs 1 and 3 in FIG. 20A, and a coloration ID is changed in this example. FIG. 20B illustrates 100 new combinations generated by repeating the above-described procedure.

This configuration makes it possible to search for a combination effectively based on an evaluation value of the total impression distance and the design similarity degree. In the present exemplary embodiment, 100 combinations are generated, but the number of combinations is not so limited. In addition, tournament selection and uniform crossover are used, but a method used is not limited to this. For example, another method, such as ranking selection, roulette selection, or one-point crossover, may be used. In addition, by incorporating mutation, the algorithm may be prevented from ending with a local optimal solution. As components of promotional materials that are to be searched for, skeletons (arrangement), coloration patterns, and fonts, logos, and patterns are used, but other components may be used. Increase of the number of components to be searched for makes it possible to generate wider variations of posters, and increase the range of impression expression.

In step S1803, similarly to step S1802, a multiple-promotional-material selection unit 1703 calculates an evaluation value of the total impression distance and the design similarity degree, and generates the same table as the table illustrated in FIG. 20A. The multiple-promotional-material selection unit 1703 stores, in the RAM 103, a promotional material set with an evaluation value of the total impression distance and the design similarity degree that is equal to or smaller than a predetermined threshold value. Furthermore, the multiple-promotional-material selection unit 1703 determines whether the number of promotional material sets stored in the RAM 103 has reached the predetermined number of combinations. In a case where the multiple-promotional-material selection unit 1703 determines that the number of promotional material sets has reached the predetermined number of combinations (YES in step S1803), the processing proceeds to step S916. In a case where the multiple-promotional-material selection unit 1703 determines that the number of promotional material sets has not reached the predetermined number of combinations (NO in step S1803), the processing returns to step S1801. In other words, the above-described processing in the second loop of step S1801 is executed, and the processing in steps S1801 to S1802 is repeated executed until the number of promotional material sets stored in the RAM 103 that have evaluation values of total impressions distance and design similarity degrees that are equal to or smaller than the threshold value reaches the predetermined number. In a case where the number of stored promotional material sets having evaluation values equal to or smaller than the threshold value becomes equal to or larger than the predetermined number, the multiple-promotional-material selection unit 1703 may compare the stored evaluation values of the promotional material sets, and finally store, in the RAM 103, promotional material sets with smaller evaluation values. Then, a promotional material set determined to have a larger evaluation value, based on a comparison result may be deleted from the RAM 103.

In the present exemplary embodiment, a search for a combination of poster components and design elements that is based on the genetic algorithm is performed, but a search method is not limited to this. Another search method, such as a neighborhood search method and a tabu search method, may be used.

As described above, according to the present exemplary embodiment, searching for a combination of components and design elements that are to be used in promotional materials makes it possible to generate a promotional material set having an impression close to a target impression and a uniform design between a plurality of generated promotional materials. This configuration is effective especially when a promotional material set is generated in accordance with an image and character information entered by the user. For example, a case is given where the user desires to generate a promotional material set having a calm impression as the entire promotional material set although an image has a vigorous impression. In the present exemplary embodiment, by evaluating an impression of the entire promotional material, it is possible to search for a combination of a skeleton, a coloration pattern, a font, a logo, and a pattern that brings an impression close to a target impression and has a high design similarity degree.

Thus, to suppress an impression given by the image, components of the promotional material can be controlled in accordance with the image by using a skeleton with a small image area or using quieter font and color. Furthermore, also in a case where an impression intended by the user and an impression given by brand information are different from each other, a skeleton with a small area in which the brand information is arranged can be used. According to the present exemplary embodiment, a combination of components optimum for the impression of the entire promotional material set and uniform design elements can be flexibly found, and various promotional material sets representing an impression of brand that is uniform and is intended by the user can be generated.

A third exemplary embodiment will be described. In the first and second exemplary embodiments, the example of generating a promotional material based on setting values set on the application activation screen 501 has been described. In the third exemplary embodiment, an example of generating a new promotional material based on stored promotional material data will be described. Promotional materials once generated are repeatedly used for generating promotional materials for seasonal events. In this case, to make a brand widely-recognized, it is necessary to generate promotional materials while repeatedly reflecting the same design or the impression in the promotional materials instead of varying designs each time. In the present exemplary embodiment, by reflecting impression information and brand information about the last promotional material in an activation screen, it is possible to generate a promotional material representing an impression of a brand that is intended by the user.

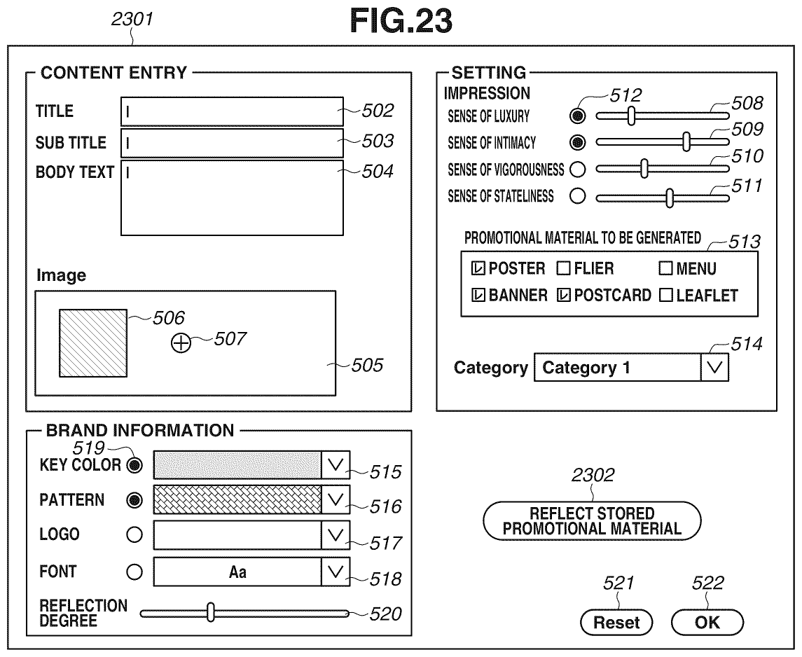

FIG. 23 is a diagram illustrating an example of an application activation screen 2301 to be provided by the multiple-promotional-material generation application according to the third exemplary embodiment. The application activation screen 2301 is displayed in the processing in step S901. The components denoted by the same reference numerals as those in FIG. 5 perform the same pieces of processing as those described in the first exemplary embodiment, and the description thereof will be omitted.

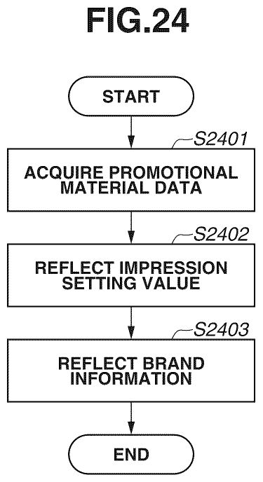

A reflect stored promotional material button 2302 for reflecting stored promotional data enables promotional material data stored by pressing the save button 605 on the multiple-promotional-material preview screen 601, to be reflected in settings on the application activation screen 2301. FIG. 24 is a flowchart illustrating processing to be executed when the reflect stored promotional material button 2302 is pressed.

In step S2401, a UI (not illustrated) that allows selection of previously-stored promotional material data is displayed, and promotional material data desired to be reflected is selected. The selected promotional material data is stored into the RAM 103.

In step S2402, an impression setting value is acquired from the selected promotional material data and reflected in the settings on the application activation screen 2301. Specifically, a target impression is acquired from the selected promotional material data, and reflected in the impression sliders 508 to 511 and the impression enabling radio button 512 on the application activation screen 2301. To reflect the stored promotional data in the settings, in a case where the impression enabling radio button 512 is not set, an impression with a larger absolute impression value is enabled and an impression with a smaller absolute impression value is disabled. An impression with a larger absolute impression value can be estimated to be an impression representing a brand, and thus the impression is enabled. Specifically, in a case where an absolute impression value is larger than 1, the impression is enabled. In addition, impressions may be compared and the top two impressions with larger absolute impression values may be enabled. The user can thereby set an impression value for repeatedly giving the same impression without specific consciousness.

In step S2403, brand information is acquired from the selected promotional material data and reflected in the settings on the application activation screen 2301. Specifically, brand information is acquired from the selected promotional material data and reflected in the key color designation box 515, the pattern designation box 516, the logo designation box 517, the font designation box 518, and the reflection degree slider bar 520 on the application activation screen 2301. The user can thereby set impression values for repeatedly including the same design elements, without specific consciousness.

After impression information about the last promotional material and brand information are reflected, by entering contents and selecting a promotional material and a category, the user can generate a plurality of promotional materials. A method of generating a plurality of promotional materials is similar to that in the first and second exemplary embodiments.

The user can thereby repeatedly generate promotional materials with the same impression and same design elements without specific consciousness. Furthermore, entering contents desired to be arranged makes it possible to generate the most appropriate promotional material for the entered contents and the impression and brand information of the last promotional material.

### Other Exemplary Embodiments

The above-described exemplary embodiments are implemented also by executing the following processing. More specifically, the processing is processing of supplying software (program) for implementing the functions of the above-described exemplary embodiments, to a system or an apparatus via a network or various storage media, and a computer (CPU or a micro processing unit (MPU)) of the system or the apparatus reading out the program and executing the program. The program may be executed by one computer or may be executed by a plurality of computers in cooperation. In addition, all of the above-described processing needs not be implemented by software. Part or all of the processing may be implemented by hardware, such as an application specific integrated circuit (ASIC). In addition, the number of CPUs is not limited to one CPU that performs all pieces of processing, and a plurality of CPUs may perform processing while appropriately taking cooperation. Cases are not limited to a case where the functions of the above-described exemplary embodiments are implemented by a computer executing a read program code. The cases also include a case where an operating system (OS) operating on the computer performs part or all of actual processing based on the instruction of the program code, and the functions of the above-described exemplary embodiments are implemented by the processing.

According to the exemplary embodiments of the present disclosure, a plurality of promotional materials having a uniform design between the plurality of promotional materials can be appropriately generated while the plurality of promotional materials represent an impression intended by the user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-026874, filed Feb. 24, 2023, which is hereby incorporated by reference herein in its entirety.

What is claimed is:

1. An information processing apparatus comprising:
a first reception unit configured to receive, from a user, designation of a target impression to be given by a plurality of promotional materials to be generated; and
a generation unit configured to generate the plurality of promotional materials based on the target impression and a design similarity degree between a plurality of promotional materials.

2. The information processing apparatus according to claim 1, further comprising a second reception unit configured to receive, from a user, designation of a design element to be included in the plurality of promotional materials to be generated.

3. The information processing apparatus according to claim 2, further comprising a first display unit configured to display a screen for receiving designation of the design element from a user,
wherein the second reception unit receives designation of the design element from a user via a screen displayed by the first display unit.

4. The information processing apparatus according to claim 1, wherein the design similarity degree is determined based on at least one of a logo, coloration, a font, and a pattern.

5. The information processing apparatus according to claim 1, further comprising a second display unit configured to display the plurality of promotional materials,
wherein the first reception unit sets, as a target impression, an estimated impression value of a first promotional material selected from among a plurality of promotional materials with different target impressions that are displayed by the second display unit.

6. The information processing apparatus according to claim 5, wherein a second promotional material is generated based on a design element included in the first promotional material.

7. The information processing apparatus according to claim 6, wherein a design similarity degree between the first promotional material and the second promotional material is smaller than a predetermined threshold value.

8. The information processing apparatus according to claim 7, wherein at least one of a logo, coloration, a font, and a pattern is identical as the design element included in the first promotional material and a design element included in the second promotional material.

9. The information processing apparatus according to claim 7,
wherein a second reception unit further receives a reflection degree, and
wherein the generation unit generates a promotional material based on the reflection degree.

10. The information processing apparatus according to claim 9, wherein the generation unit change changes a value of the threshold value of design similarity degree based on the reflection degree.

11. A control method for an information processing apparatus, the control method comprising:
receiving, from a user, designation of a target impression to be given by a plurality of promotional materials to be generated; and
generating a plurality of promotional materials based on the target impression and a design similarity degree between a plurality of promotional materials.

12. A non-transitory computer-readable storage medium storing computer-executable instructions that, when executed by a computer, cause the computer to perform a control method, the control method comprising:
receiving, from a user, designation of a target impression to be given by a plurality of promotional materials to be generated; and
generating a plurality of promotional materials based on the target impression and a design similarity degree between a plurality of promotional materials.
